(19) United States
(12) Patent Application Publication
(10) Pub. No.: US 2010/0201774 A1
(43) Pub. Date: Aug. 12, 2010

(54) NEWSPAPER PRODUCTION SYSTEM AND PRODUCTION METHOD FOR NEWSPAPER

(75) Inventor: Kazuyuki Motojima, Kanagawa (JP)

Correspondence Address: FOLEY AND LARDNER LLP;SUITE 500, 3000 K STREET NW, WASHINGTON, DC, 20007, US

(73) Assignee: Tokyo Kikai Seisakusho, Ltd.

(21) Appl. No.: 12/599,006

(22) PCT Filed: Mar. 26, 2008
(86) PCT No.: PCT/JP2008/056511

§ 371 Date: Apr. 26, 2010

(51) Int. Cl. B41J 2/01

(52) U.S. Cl. 347/104

(57) ABSTRACT

An object of this invention is to provide a newspaper production system, having the structure of a system that is provided with a supply unit for a continuous web provided at an upstream side of a printing unit for printing on one surface and the other surface of a continuous web, and a processing unit for carrying out cutting and folding processing of a continuous web after printing at a downstream side, by making the area of an installation flat region for the printing unit for printing on one surface and the other surface of a continuous web, having an ink jet printing device group for printing one side of the continuous web and an ink jet printing device group for printing the other side of the paper sheet, small, and with which it is easy for a single person to carry out a newspaper production operation of monitoring the entire system. It is also an object of this invention to provide a newspaper production system and newspaper production method that enables production of a few sizes of a plurality of newspaper pages arranged horizontally as sheets constituting a newspaper by sequentially cutting, and being capable of producing a newspaper formed of various page configurations.

### TECHNICAL FIELD

The present invention relates to a newspaper production system provided with an ink jet printing unit for performing ink jet printing on one surface and the other surface of a continuous web, and to a production method for newspapers using the newspaper production system.

### BACKGROUND ART

A printing unit for printing on one surface and the other surface of a continuous web using ink jet printing devices is disclosed in Japanese Unexamined Patent Publication No. He. 11-320923 (related art 1), Japanese Unexamined Patent Publication No. 2001-58446 (related art 2) and Japanese Unexamined Patent Publication No. 2003-11452 (related art 3). A production method for newspapers using a digital printing device including an ink jet printing unit is disclosed in Japanese Unexamined Patent Publication No. 2003-341927 (related art 4).

The printing unit for printing on one surface and the other surface of a continuous web disclosed in related art 1 and related art 2 has an ink jet printing unit with an ink jet print head arranged so that ink jets are formed in a cross direction of the continuous web. Specifically, the ink jet printing units (a number of the units is equal to the number of inks used in printing on one side of the continuous web) are arranged at regular intervals in the length direction of the continuous web. Next to this arrangement, other ink jet printing units (a number of the units is equal to the number of inks used in printing the other side of the continuous web) are arranged at regular intervals in the length direction of the continuous web. A continuous web reverse travel mechanism is provided so that a continuous web, that has been guided below an ink jet printing unit for printing one side, is fed above the ink jet printing unit for printing the other side. And then, after it has passed the ink jet printing unit for printing the other side, the guiding direction is reversed. The surface of the continuous web has been turned upside down as a result of this reversing. The continuous web is guided below the ink jet printing unit for printing the other surface. Accordingly, a continuous web is first guided below an ink jet printing unit for printing one side, and that one side is printed, then the continuous web is reversed by the continuous web reverse travel mechanism, and in the turned over state is guided below the ink jet printing unit for printing the other side, and the other side is printed, and after that the travel direction is reversed again and the continuous web is guided outside the continuous web double sided printing unit.

The printing unit for printing on one surface and the other surface of a continuous web of related art 3 is provided with a turn bar for changing the travel direction of a continuous web traveling substantially horizontally through 90 degrees, and also turning over the continuous web and causing it to travel substantially horizontally. The printing unit is provided with ink jet printing units for printing one side of the continuous web being arranged at regular intervals in the travel direction, above the traveling path of the continuous web facing the turn bar. The printing unit is also provided with other ink jet print units for printing the other side of the continuous web being arranged at regular intervals in the travel direction above the traveling path of the continuous web that has passed the turn bar. Accordingly, the continuous web is first made to travel along the travel route of the continuous web facing the turn bar, to print one side, then the continuous web is reversed by the turn bat and in the turned over state made to travel the traveling path of the continuous web that passed through the turn bar to print the other side.

Also, the newspaper manufacturing method of related art 4 is a method in which a plurality of lateral printed rows, having different printing content for each printing line, the lateral printed rows having at least two printed surfaces corresponding to each other on either side of a continuous web in a cross direction of the continuous web, are handled as one print cycle, are repeatedly printed on both sides of the continuous web in a printing direction using a digital printing device, a cut is made for every double sided double spread, and for each lateral printed row, setting is performed for each printing cycle, and for each setting a double spread is folded to produce newspapers of a number of pages corresponding to the number of printing cycles.

In related art 4, as a system for executing the newspaper manufacturing method, a mechanism is disclosed in which a continuous web is supplied from an upstream side of the digital printing device, the continuous web is cut to a specified size at a downstream side of the digital printing device, and the cut sheets are stacked to a specified number and folded.

As disclosed in related art 3, in the current technology it is a precondition for an ink jet print head for printing a continuous web that the ink discharge ports face downwards, and a continuous web that is to be printed on must have a printing surface facing upwards, and be guided underneath the ink jet print head.

However, the related arts the above description have the following problems.

Specifically, the printing unit for printing on one surface and the other surface of a continuous web as disclosed in related art 1 and related art 2 has an ink jet printing unit group for printing one side and an ink jet printing unit group for printing the other side aligned on a substantially horizontal plane and in the same direction, and arranged spaced apart from each other at regular intervals. This gives a printing unit for printing on one surface and the other surface of a continuous web that is long in the arrangement direction, and necessitates a long flat region for installation. Also, the printing unit for printing on one surface and the other surface of a continuous web generally has a supply unit for the continuous web provided at an upstream side and a processing unit for appropriately processing the continuous web after printing arranged at a downstream side, and is used as a ink jet printing system for a continuous web, to carry out printing and post printing processing in a consistent manner, but with such a ink jet printing system for a continuous web the overall length of the system becomes longer, and when a single person carries out continuous operation of monitoring the overall system they must stay alert and must never be absent.

The printing unit for printing on one surface and the other surface of a continuous web disclosed in related art 3 has an ink jet printing unit group for printing one side and an ink jet printing unit group for printing the other side arranged on a substantially horizontal plane but with row directions differing by 90 degrees, and spaced apart at regular intervals, with a turn bar provided between the two ink jet printing unit groups in a state inclined by 45 degrees with respect to the row direction of the ink jet print unit group for printing on the one side, and a continuous web that has passed through the ink jet printing unit group for printing the one side traveling substantially horizontally and been printed on the one side is rotated through 180 degrees on the peripheral surface of the turn bar so as to be turned upside down, and the substantially horizontal traveling direction is changed by 90 degrees to guide the continuous web to the ink jet printing unit group for printing the other side, and the other side is printed. Therefore, the length in one direction is shorter than the printing unit for printing on one surface and the other surface of a continuous web disclosed in related art 1 and related art 2, but is not really that different in total length, and since the ink jet printing unit group for printing one side and the ink jet printing unit group for printing the other side are arranged with arrangement directions 90 degrees different from each other it requires a rectangular flat installation region that is wider than the installation region for the printing unit for printing on one surface and the other surface of a continuous web disclosed in related art 1 and related art 2, where lengths in which at least a group of ink jet printing devices are arranged are taken as two adjacent sides.

Also, the printing unit for printing on one surface and the other surface of a continuous web, similarly to the printing unit for printing on one surface and the other surface of a continuous web disclosed in related art 1 and related art 2, generally has a feed unit for the continuous web and a processing unit for suitably processing the continuous web after printing arranged at an upstream side and a downstream side respectively, and is used as an ink jet printing system for a continuous web for carrying out printing and post printing processing in a consistent fashion. However, with this type of ink jet printing system for a continuous web, it is necessary for a rectangular flat installation space for installation of the entire system to be wider, and when a single person carrying out continuous operations to monitor the overall system they must stay alert and be constantly present.

On the other hand, the newspaper manufacturing method of related art 4 is a method in which a plurality of lateral printed rows, each having different print content, and with each row having at least two printed segments corresponding to each other on both sides of a continuous web in a cross direction of the continuous web, are handled as one print cycle, with repeated printing in a printing direction, a cut is made for every lateral printed row and for every double sided double spread, setting is performed for each printing cycle, and for each setting a double spread is folded to manufacture newspapers of a number of pages corresponding to the number of printing cycles.

Therefore, when a digital printing device has an ink jet printing unit, in printing newspapers of a blanket size (broadsheet), the fact that printing is possible for an advertisement page spanning two whole adjacent newspaper pages, which has recently become common, means it is necessary for the ink jet print heads to be small, and to have a width enabling printing of two newspaper pages that are next to each other in a cross direction, that is, a width in excess 800 mm, but operating such a wide in jet print head with good precision is extremely difficult, and inevitable leads to high costs. Also, printing an advertisement page spanning the whole of two adjacent pages of a newspaper with two ink jet print heads each capable of printing one page of a newspaper is not inconceivable, but installing the ink jet print head to be aligned with good precision, so that there are no streaks remaining such as portions where printing does not occur at the boundaries of printing image using double sided ink jet print heads, or portions where printing has overlapped, is extremely difficult. In addition, in any event maintenance is not simple, and the burden placed on an operator increases with the size of the system or with precision becoming more important. Also, a cut is made for each sideways print line, and for each double spread, which means that also in cases where two or more pages are printed on a continuous web of large paper width, it is difficult to make cuts changing the number of pages arranged for each sideways printing row, it is not possible to obtain a paper space of a single page size, or a large page space where three pages or more are arranged sideways such as in what is called a desired panorama page which there has recently been a demand for, and it is not possible to produce newspapers having a page form with variable folding.

### DISCLOSURE OF THE INVENTION

An object of this invention is to provide a newspaper production system, having the structure of a system that is provided with a supply unit for a continuous web provided at an upstream side of a printing unit for printing on one surface and the other surface of a continuous web, and a processing unit for carrying out cutting and folding processing of a continuous web after printing at a downstream side, by making the area of an installation flat region for the printing unit for printing on one surface and the other surface of a continuous web, having an ink jet printing unit group for printing one side of the paper sheet and an ink jet printing unit group for printing the other side of the paper sheet, small, and with which it is easy for a single person to carry out a newspaper production operation of monitoring the entire system. It is also an object of this invention to provide a newspaper production system and newspaper production method that enable continuous cut production of a few sizes of a plurality of newspaper pages arranged horizontally as sheets constituting a newspaper, and being capable of producing a newspaper formed of various page configurations.

This invention is a newspaper production system including, an ink jet printing unit having ink jet printing devices, each having an ink jet printing head, provided at a plurality of levels in a vertical direction, and capable of printing on the one surface and the other surface of the continuous web, a continuous web supply unit provided at an upstream side of the ink jet printing unit capable of printing on the one surface and the other surface of the continuous web and capable of supplying the continuous web from a continuous web roll to the ink jet printing unit capable of printing on the one surface and the other surface of the continuous web, at least one processing unit provided at a downstream side of the ink jet printing unit capable of printing on the one surface and the other surface of the continuous web, having a cutting mechanism and a folding mechanism, capable of cutting the continuous web that has been printed by the ink jet printing unit capable of printing on the one surface and the other surface to a predetermined size, and capable of folding the cut sheets, and, control member for controlling to cause the continuous web to travel from the continuous web supply unit, via the ink jet printing unit capable of printing on the one surface and the other surface of the continuous web, to the processing unit, and controlling to correlate printing of each page of the newspaper by the ink jet printing unit capable of printing on the one surface and the other surface of the continuous web, in accordance with a travel speed of the continuous web, and the cutting and folding by the processing unit, wherein the control member causes the ink jet printing unit capable of printing on the one surface and the other surface of the continuous web to align printing positions of each page of the newspaper on the one surface and the other surface of the continuous web such that a height direction of the newspaper is placed parallel to a cross direction of the continuous web, and while considering a predetermined number of pages constituting one part of a newspaper as one set, to arrange the pages of a newspaper next to each other in a running direction of the continuous web to repetitively print for every set, and causes the processing unit to cut the continuous web that has been printed by the ink jet printing unit capable of printing on the one surface and the other surface of the continuous web to form a rectangular cut sheet having a size of a number of pages, being a natural number, printed side by side, in which the same number of pages, being the natural number, are printed on the one surface and the other surface of the rectangular cut sheet and a length of one set of two parallel sides is equal to a height direction length of the newspaper, then to fold the cut sheets having a size of three or more pages of a newspaper printed side by side, among the rectangular cut sheets, to a size that is, at largest, that of two pages of a newspaper printed side by side, then to stack each of the cut sheets in a number constituting one part of a newspaper to thereby form a bundle of cut sheets for every one part of the newspaper, and to fold the bundle of cut sheets for every one part of the newspaper to thereby form a signature newspaper.

Also, the control member of the newspaper production system of this invention carries out control to cause the processing unit to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, to stack the cut sheets having a size of two pages of a newspaper printed side by side in a number constituting one part of a newspaper to thereby form a bundle of cut sheets for every one part of the newspaper, and to fold the bundle of cut sheets for every one part of the newspaper to thereby form a signature newspaper.

Further, the control member of the newspaper production system of this invention carries out control to cause the processing unit to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, to form rectangular cut sheets having a size of one printed page of a newspaper for every formation of a predetermined number of cut sheets having a size of one page of a newspaper printed, in which one page of a newspaper is printed on the one surface and the other surface of the rectangular cut sheet and a length of one set of two parallel sides is equal to the height direction length of the newspaper, to stack the cut sheets having a size of two pages printed side by side and the cut sheets having a size of one printed page of a newspaper in a number constituting one part of the newspaper such that the cut sheets having a size of one printed page of a newspaper overlap on one of the pages printed on the cut sheets having a size of two pages printed side by side to thereby form a bundle of cut sheets for every one part of the newspaper, and to fold the bundle of cut sheets for every one part of the newspaper to thereby form a signature newspaper.

Also, the control member of the newspaper production system of this invention causes the processing unit to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, to form, for every formation of a predetermined number of cut sheets having a size of two pages of a newspaper printed side by side, rectangular cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper, to make the rectangular cut sheets having a size of three pages of a newspaper printed side by side to the same size as that of the cut sheet having a size of two pages of a newspaper printed side by side by folding either one of the side pages thereof to overlap on the middle pages thereof, to make the rectangular cut sheets having a size of four pages of a newspaper printed side by side to the same size as that of the cut sheets having a size of two pages of a newspaper printed side by side by folding the respective side pages thereof to overlap on respective adjacent pages thereof, and to stack, in a number constituting one part of the newspaper, the cut sheets having a size of two pages of a newspaper printed side by side, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the same size as that of the cut sheets having a size of two pages of a newspaper printed side by side, to thereby form a bundle of cut sheets for every one part of the newspaper, and to fold the bundle of cut sheets for every one part of the newspaper to thereby form a signature newspaper.

Still further, the control member of the newspaper production system of this invention causes the processing unit to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, to form, for every formation of a predetermined number of cut sheets having a size of two pages of a newspaper printed side by side, rectangular cut sheets having a size of one printed page of a newspaper, in which one page of a newspaper is printed on the one surface and the other surface of the rectangular cut sheet and a length of one set of two parallel sides is equal to the height direction length of the newspaper, cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper, to make the rectangular cut sheets having a size of three pages of a newspaper printed side by side the same size as that of the cut sheet having a size of two pages of a newspaper printed side by side by folding either one of the side pages thereof to overlap on the middle pages thereof, to make the rectangular cut sheets having a size of four pages of a newspaper printed side by side the same size as that of the cut sheets having a size of two pages of a newspaper printed side by side by folding the respective side pages thereof to overlap on respective adjacent pages thereof, and to stack, in a number constituting one part of the newspaper, the cut sheets having a size of two pages of a newspaper printed side by side, the cut sheets having a size of one page of the newspaper printed, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the size as that of a size of two pages of a newspaper printed side by side such that the cut sheets having a size of one printed page of the newspaper overlap on one of the pages printed on the cut sheets having a size of two pages printed side by side to thereby form a bundle of cut sheets for every one part of the newspaper, and to fold the bundle of cut sheets for every one part of the newspaper to thereby form a signature newspaper.

Also, this invention is a production method for newspapers, for producing newspapers, using an ink jet printing unit having ink jet printing devices, each having an ink jet printing head, provided at a plurality of levels in a vertical direction, and capable of printing on the one surface and the other surface of the continuous web; a continuous web supply unit provided at an upstream side of the ink jet printing unit capable of printing on the one surface and the other surface of the continuous web and capable of supplying the continuous web from a continuous web roller to the ink jet printing unit capable of printing on the one surface and the other surface of the continuous web; at least one processing unit provided at a downstream side of the ink jet printing unit capable of printing on the one surface and the other surface of the continuous web, having a cutting mechanism and a folding mechanism, capable of cutting the continuous web that has been printed by the ink jet printing unit capable of printing on the one surface and the other surface to a predetermined size, and capable of folding the cut sheets; and control member for controlling to cause the continuous web to travel from the continuous web supply unit, via the ink jet printing unit capable of printing on the one surface and the other surface of the continuous web, to the processing unit, and controlling to correlate printing of each page of the newspaper by the ink jet printing unit capable of printing on the one surface and the other surface of the continuous web, in accordance with a travel speed of the continuous web, and the cutting and folding by the processing unit, comprising: a newspaper sheet printing step of printing on the one surface and the other surface of the continuous web to align printing positions of each page of the newspaper on the one surface and the other surface of the continuous web such that a height direction of the newspaper is placed parallel to a cross direction of the continuous web, and while considering a predetermined number of pages constituting one part of a newspaper as one set, to arrange the pages of a newspaper next to each other in a running direction of the continuous web to repetitively print for every set, a newspaper sheet cutting step of cutting the continuous web that has been printed by the ink jet printing unit capable of printing on the one surface and the other surface of the continuous web to form a rectangular cut sheet having a size of a number of pages, being a natural number, printed side by side, in which the same number of pages, being the natural number, are printed on the one surface and the other surface of the rectangular cut sheet and a length of one set of two parallel sides is equal to a height direction length of the newspaper, a first folding step of folding the cut sheets having a size of three or more pages of a newspaper printed side by side, among the rectangular cut sheets, to a size that is, at largest, that of two pages of a newspaper printed side by side, a newspaper sheet stacking step of stacking each of the cut sheets in a number constituting one part of a newspaper to thereby form a bundle of cut sheets for every one part of the newspaper, and a second folding step of folding the bundle of cut sheets for every one part of the newspaper to thereby form a signature newspaper.

Also the newspaper sheet cutting step of the newspaper production method of this invention is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, the newspaper sheet stacking step is a step of stacking the cut sheets having a size of two pages of a newspaper printed side by side in a number constituting one part of a newspaper to thereby form a bundle of cut sheets for every one part of the newspaper, and the second folding step is a step of folding the bundle of cut sheets for every one part of the newspaper to thereby form a signature newspaper.

Further the newspaper sheet cutting step of the newspaper production method of the present invention is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, and forming rectangular cut sheets having a size of one printed page of a newspaper for every formation of a predetermined number of cut sheets having a size of two pages of a newspaper printed side by side, in which one page of a newspaper is printed on the one surface and the other surface of the rectangular cut sheet and a length of one set of two parallel sides is equal to the height direction length of the newspaper, the newspaper sheet stacking step is a step of stacking the cut sheets having a size of two pages printed side by side and the cut sheets having a size of one printed page of a newspaper in a number constituting one part of the newspaper such that the cut sheets having a size of one printed page of a newspaper overlap on one of the pages printed on the cut sheets having a size of two pages printed side by side to thereby form a bundle of cut sheets for every one part of the newspaper, and the second folding step is a step of folding the bundle of cut sheets for every one part of the newspaper to thereby form a signature newspaper.

Also the newspaper sheet cutting step of the newspaper production method of the present invention is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, and forming, for every formation of a predetermined number of cut sheets having a size of two pages of a newspaper printed side by side, rectangular cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper, the first folding step is a step of to make the rectangular cut sheets having a size of three pages of a newspaper printed side by side to the same size as that of the cut sheet having a size of two pages of a newspaper printed side by side by folding either one of the side pages thereof to overlap on the middle pages thereof, so as to make the rectangular cut sheets having a size of four pages of a newspaper printed side by side to the same size as that of the cut sheets having a size of two pages of a newspaper printed side by side by folding the respective side pages thereof to overlap on respective adjacent pages thereof, the newspaper sheet stacking step is a step of stacking, in a number constituting one part of the newspaper, the cut sheets having a size of two pages of a newspaper printed side by side, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the same size as that of the cut sheets having a size of two pages of a newspaper printed side by side, to thereby form a bundle of cut sheets for every one part of the newspaper, and the second folding step is a step of folding the bundle of cut sheets for every one part of the newspaper to thereby form a signature newspaper.

Still further the newspaper sheet cutting step of the newspaper production method of the present invention is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, and forming, for every formation of a predetermined number of cut sheets having a size of two pages of a newspaper printed side by side, rectangular cut sheets having a size of one printed page of a newspaper, in which one page of a newspaper is printed on the one surface and the other surface of the rectangular cut sheet and a length of one set of two parallel sides is equal to the height direction length of the newspaper, cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper, the first folding step is a step of to make the rectangular cut sheets having a size of three pages of a newspaper printed side by side the same size as that of the cut sheet having a size of two pages of a newspaper printed side by side by folding either one of the side pages thereof to overlap on the middle pages thereof, to make the rectangular cut sheets having a size of four pages of a newspaper printed side by side the same size as that of the cut sheets having a size of two pages of a newspaper printed side by side by folding the respective side pages thereof to overlap on respective adjacent pages thereof, the newspaper sheet stacking step is a step if stacking, in a number constituting one part of the newspaper, the cut sheets having a size of two pages of a newspaper printed side by side, the cut sheets having a size of one page of the newspaper printed, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the size as that of a size of two pages of a newspaper printed side by side such that the cut sheets having a size of one printed page of the newspaper overlap on one of the pages printed on the cut sheets having a size of two pages printed side by side to thereby form a bundle of cut sheets for every one part of the newspaper, and the second folding step is a step of folding the bundle of cut sheets for every one part of the newspaper to thereby form a signature newspaper.

According to this invention, since an ink jet printing unit for a continuous web is configured provided with a plurality of ink jet print heads in a vertically stacked state, a flat region for installation of the ink jet printing unit for a continuous web can be made smaller by up to about half compared to the related art. Accordingly, it is possible to make a newspaper production system, provided with a continuous web supply unit at an upstream side of the ink jet printing unit for a continuous web, and provided with a processing unit for cutting and folding the continuous web at a downstream side of the ink jet printing unit for a continuous web, small and compact. Also, since the ink jet printing unit for a continuous web is configured so as to print by sequentially passing the continuous web from an upper stage to a lower stage in a zigzag fashion, a continuous web that has been printed on a first printing surface at the upper level can be guided by a roller that contacts a second printed surface, which is the reverse surface of the first printed surface, to below the ink jet print heads of the lower level, and the second printing surface can be guided upwards, and it is possible to carry out printing to the second printing surface with the ink jet print heads of the lower level, without lowering of quality due to degradation on the first printing surface that has just been printed etc. Furthermore, when this continuous web is guided below ink jet print heads at a still lower level, guiding is possible using a roller that contacts a first paper surface on which printed ink has stabilized while waiting for completion of printing to the second surface, and even in the event that the printed image of the first printing surface is rubbed by the roller contacting this surface there is hardly any lowering of quality due to smearing etc. Also, there is no lowering of quality due to smearing of the printed image of the second paper surface that has just been printed, and it is possible to carry out printing on the first paper surface using ink jet print heads at a lower level. Then, using a similar operation the second paper surface and the first paper surface are changed over, and it is possible to perform sequential printing according to the number of overlapped ink jet heads. As a result it is possible to acquire a printed product of good quality.

Also, since printing of the newspaper pages is carried out with a vertical direction of one page of the newspaper made parallel to the paper width, then even in the case of printing a blanket sized (broadsheet) newspaper the ink jet print heads suffice with the vertical dimension of one newspaper page, that is, a width of 547 mm, even if the paper is large. Operating the ink jet print heads with good precision is therefore comparatively easy, and is correspondingly less inexpensive, maintenance becomes comparatively easy and it is possible to lighten the load on an operator.

Further, sideways printing is possible for newspaper pages in a feed direction of the continuous web, and as a result an advertisement page spanning two adjacent sheets, and even an advertisement page spanning three or more adjacent pages can be printed using the same ink jet print head.

Also, by controlling operation speed of the cutting mechanism with respect to the traveling speed of the continuous web to appropriately vary the longitudinal direction cutting position of the continuous web, clipping of cut sheets in a state newspaper pages have been laid sideways in an appropriate number is extremely easy, and it is possible to produce newspapers comprising a varying number of pages.

Still further, even in a case where the width of the continuous web is large, a vertical direction of one newspaper page is made parallel to the cross direction of the paper, and printing is carried out for a few newspaper pages laid out in the cross direction of the paper, in the shape of a newspaper, there are parts between two pages that are next to each other in the cross direction of the paper where printing is not carried out, and so it is possible to install ink jet print heads of a size capable of printing the vertical direction of one newspaper page with rough precision next to each other, and it is extremely easy to clip each divided continuous web, that has been divided after printing with a slitter in the feed direction thereof, by controlling longitudinal direction cutting position of the continuous web similarly to as described previously.

For each of the divided cut continuous webs, it is also possible to clip stacked cut sheets, and it is possible to clip cut sheets using individual cutting mechanisms. The former is preferred in production newspapers where a lot of editions do not vary in page structure, while the latter is preferred for producing newspapers where the page structure often varies, or differs with each divided continuous web.

### BRIEF DESCRIPTION OF THE DRAWINGS

FIG. 1 is a block diagram showing a structural overview of a newspaper production system of this invention.

FIG. 2 is an overall structural diagram showing the structural overview of a newspaper production system SA of a first embodiment of the present invention having an ink jet printing unit for a continuous web 1A and a processing unit 3A, and is a structure that can be applied to a continuous web W of paper width that conforms to the vertical dimension of one page of a newspaper.

FIG. 3 is a schematic diagram viewed from the direction of arrows AA of the ink jet printing unit for a continuous web 1A shown in FIG. 2.

FIG. 4 is a schematic drawing of main parts looking from the direction of arrows BB of FIG. 3.

FIG. 5(a) is an enlarged explanatory drawing of the ink jet printing unit for a continuous web 1A shown in FIG. 2 and a cutting and folding unit 3a that is on of the processing units 3A.

FIG. 5(b) is an enlarged explanatory drawing of the cutting and folding unit 3a of FIG. 5(a).

FIG. 6(a) to FIG. 6(h) are schematic drawings showing aspects of pre-folding of a cut sheet S4 having a size of four pages of a newspaper laid out sideways to a size of the width of two newspapers laid side by side by folding the two side pages inwards, using a pre-folding mechanism 6 of the cutting and folding mechanism 3a that is one of the processing units 3A shown in FIG. 2, together with main parts of the pre-folding mechanism 6, in sequence, viewed from the side of the paper.

FIG. 7(a) is an overall structural diagram showing the structural overview of a newspaper production system SB of a second embodiment of the present invention having an ink jet printing unit for a continuous web 1B and an embodiment D of a processing unit 3B, and is a structure that can be applied to a continuous web W2 of width that conforms to the vertical dimension of two pages of a newspaper.

FIG. 7(b) is an enlarged explanatory drawing of an overlapping unit 3d, a cutting unit 3f and a folding unit 3b that are the embodiment D of the processing unit 3B of FIG. 7(a).

FIG. 8 is a schematic diagram looking from the arrows CC of the ink jet printing unit for a continuous web 1B shown in FIG. 7(a).

FIG. 9 is a schematic drawing of main parts looking from arrows DD of FIG. 8.

FIG. 10 is a schematic diagram of the ink jet printing unit for a continuous web 1B that is a second embodiment of this invention shown in FIG. 7(a).

FIG. 11 is a partially enlarged explanatory diagram of a separation unit 3e and a cutting unit 3f that are an embodiment E of the processing unit 3B.

FIG. 12(a) is a drawing looking from arrow E of FIG. 7(a), and is a substantial plan view of an overlapping unit 3d that is the embodiment D of the processing unit 3B.

FIG. 12(b) is a drawing looking from the direction of arrow F of FIG. 11, and is a substantial plan view showing a separation unit 3e that is the embodiment E of the processing unit 3B.

FIG. 13(a) to FIG. 13(d) are drawings schematically showing a 1-page cut sheet S1, 2-page cut sheet S2, 3-page cut sheet S3 and 4-page cut sheet S4 formed by the cutting mechanism 5 of the cutting and folding unit 3a, with FIG. 13(a) schematically showing allocation state of printed images on a 1-page cut sheet, FIG. 13(b) schematically showing allocation states of individual printed images on each page of a 2-page cut sheet S2, FIG. 13(c) schematically showing allocation state of combined printed images spanning the whole of a 3-page cut sheet S3, for example printed images for a 3-page advertisement, and FIG. 13(d) schematically shows allocation state of combined printed images spanning the whole of a 4-page cut sheet S4, for example, printed images for a 4-page advertisement.

FIG. 14(a) is a perspective drawing of a signature SS having a size of one page of a newspaper formed using only 2-page cut sheets S2.

FIG. 14(b) is a perspective view of a signature SS of the size of one page of a newspaper formed using 2-page cut sheets S2 and 4-page cut sheets S4 folded to the size of the width of 2 pages of a newspaper laid side by side by pre-folding.

FIG. 14(c) is a plan view of FIG. 14(a).

FIG. 14(d) is a plan view of FIG. 14(b).

### DESCRIPTION OF THE PREFERRED EMBODIMENTS

Embodiments of this invention will now be described with reference to the drawings.

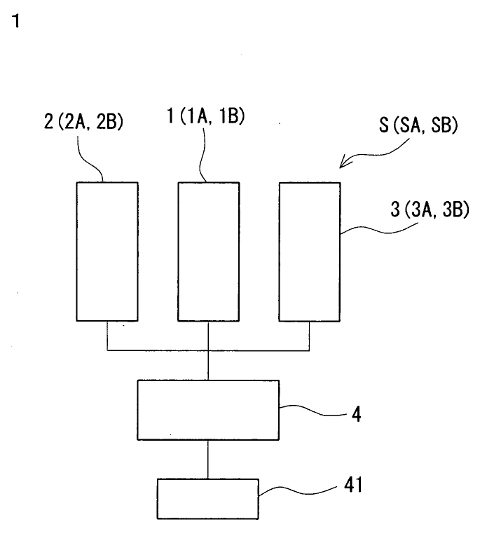

A newspaper production system S, as shown in FIG. 1, comprises a printing unit for printing on one surface and the other surface of a continuous web 1, a continuous web supply unit 2, provided at an upstream side of the printing unit for printing on one surface and the other surface of a continuous web 1, for supplying a continuous web to the printing unit for printing on one surface and the other surface of a continuous web 1, a processing unit 3, provided at a downstream side of the printing unit for printing on one surface and the other surface of a continuous web 1, for forming a continuous web that has been printed by the printing unit for printing on one surface and the other surface of a continuous web 1 into a newspaper, and control member 4 for controlling drive of each unit to adjust linkage of these units and various operation timing etc.

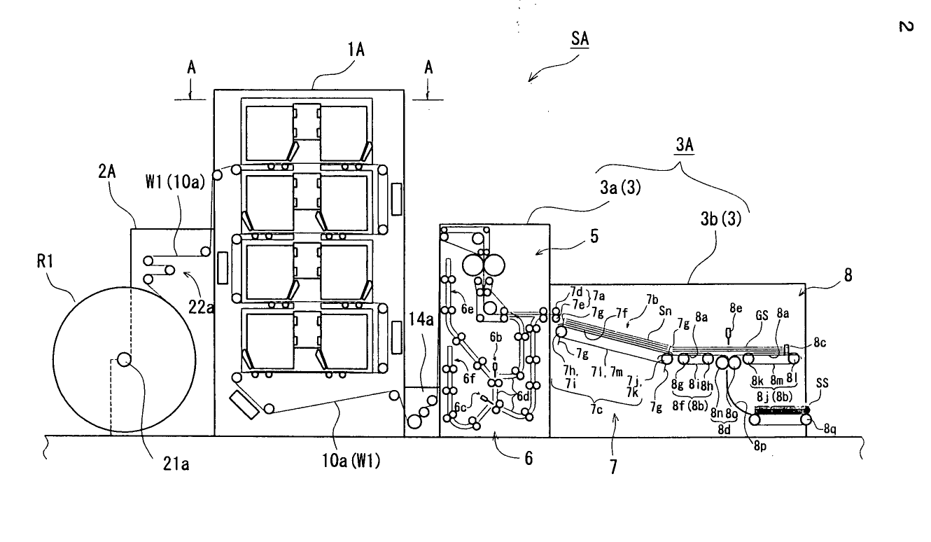

The newspaper production system SA, which is the first embodiment shown in FIG. 2, has a printing unit for printing on one surface and the other surface of a continuous web 1A and a continuous web supply unit 2A provided at an upstream side of the printing unit for printing on one surface and the other surface of a continuous web 1A, and it is possible to supply a continuous web W1 of a width conforming to the vertical dimension of one newspaper page to the printing unit for printing on one surface and the other surface of a continuous web 1A. Also, a processing unit 3A is provided at a downstream side of the printing unit for printing on one surface and the other surface of a continuous web 1A, and the continuous web W1 is cut and folded after being printed. The processing unit 3A is provided with a cutting and folding unit 3a and a folding unit 3b.

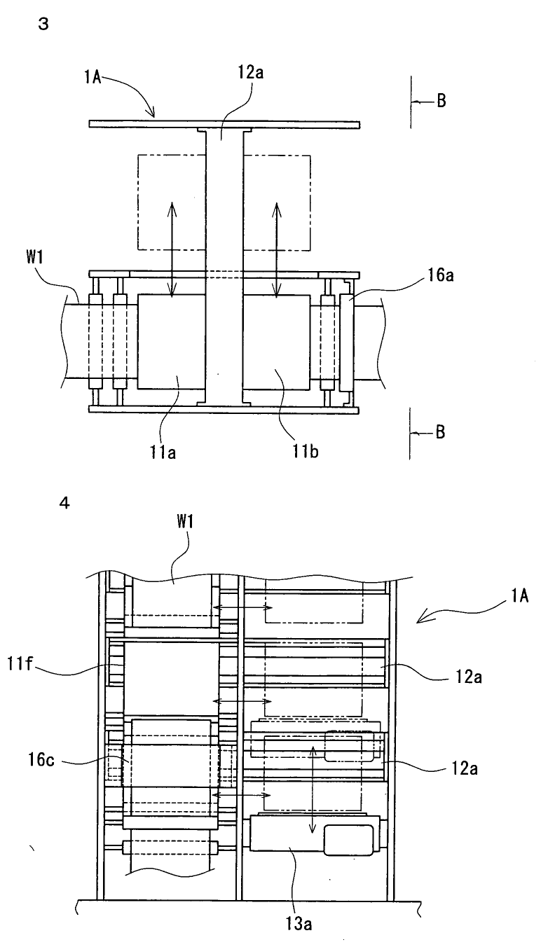

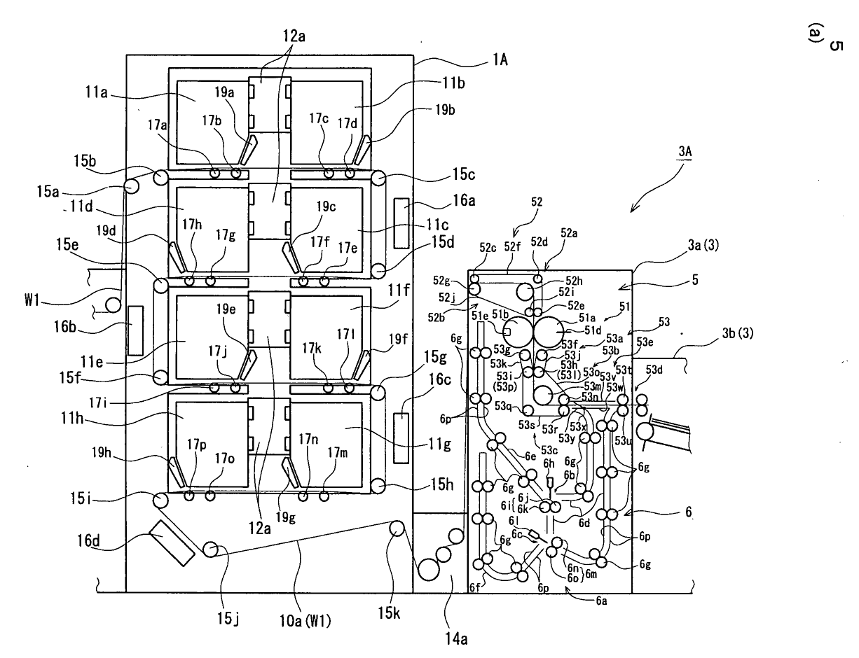

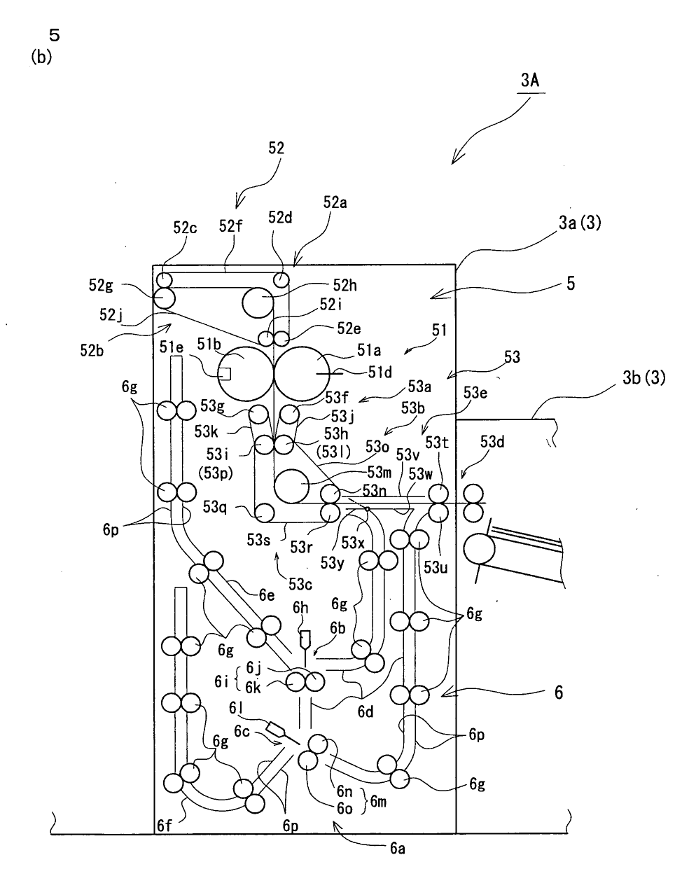

The printing unit for printing on one surface and the other surface of a continuous web 1A has ink jet printing devices 11a to 11h, having ink jet print heads (not shown) provided with a plurality of ink discharge ports spanning a dimension that is larger than the vertical direction dimension of one page of a newspaper, provided at four vertical levels, with two in each level, as shown in FIG. 5(a). Each of the ink jet printing devices 11a to 11h has the ink discharge ports facing downwards, and are provided so that when at the print position central positions in the cross direction of each of the ink jet printing devices 11a to 11h are on substantially the same plane. For example, the printing devices 11a to 11h are provided so that using a lateral movement unit 12a provided with a screw feeding mechanism (not shown), fine movement for lateral register adjustment of the printing image, and large movement to the printing position and to a maintenance position (shown by the dashed double-dotted line in FIG. 3 and FIG. 4) for performing maintenance of the ink jet print heads after printing using a maintenance unit 13a, is possible.

Also, a plurality of guide rollers 15a to 15k forming a paper run-through path 10a are provided below the ink jet printing devices 11a to 11h of each stage, that is, below the ink jet print heads of each stage, so that the continuous web W1 is capable of running through from the upper stage to the lower stage sequentially in a zigzag fashion. Drying units 16a to 16d are provided, respectively facing the paper run-through passages 10a spanning between after the paper has passed below the ink jet print heads of the upper stage and below the ink jet print heads of the next stage, and facing the run-through passage 10a after running below the ink jet print heads of the lowest stage. In FIG. 5(a), reference numerals 17a to 17p are back-up rollers, 19a to 19h are suction devices for collecting ink mist that files off at the time of printing, and 14a is a feed mechanism for feeding the continuous web W1 to the downstream side.

The continuous web supply unit 2A has a support section 21a capable of braking rotation of a continuous web roll R1 of the continuous web W of a width conforming to the vertical dimension of one page of a newspaper, and a tension detecting section 22a that is displaced in an oscillating fashion according to traveling tension of the continuous web W1, and the tension detection section 22a is provided so that strength of a braking force for braking rotation of the continuous web roll R1 can be automatically adjusted according to the magnitude of detected traveling force of the continuous web W1. The continuous web supply unit 2A is also provided with a continuous web roll lifting mechanism (not shown) for lifting the continuous web roll R1 at the time of loading the continuous web roll R1 into the support section 21a. The continuous web roll lifting mechanism is formed from a link mechanism that has a hydraulic cylinder, for example, as a drive source.

The processing unit 3A of the first embodiment comprises a cutting and folding unit 3a and a folding unit 3b, with the folding unit 3b being provided at a downstream side of the cutting and folding unit 3a.

The cutting and folding unit 3a has a cutting mechanism 5 and a pre-folding mechanism 6, as shown enlarged in FIG. 5(b). The cutting mechanism 5 is capable of cutting the continuous web W1 that has been printed by the printing unit for printing on one surface and the other surface of a continuous web 1A, and of forming cut sheets Sn having the size of a number of newspaper pages laid side by side, namely, for example, a 1-page cut sheet S1, a 2-page cut sheet S2, a 3-page cut sheet S3 and a 4-page cut sheet S4. The pre-folding mechanism 6 is capable of respectively pre-folding to a size of 2-page width utilizing folding to fold one page at either side of a 3-page cut sheet S3 formed by the cutting mechanism 5 parallel to a vertical direction of a single newspaper page so that the one page is overlapped on a center page, and folding to fold each side page of a 4-page cut sheet S4 parallel to the vertical direction of a single newspaper page so that associated adjacent pages of the 4-page cut sheet are overlapped on each other on the same side.

The folding unit 3b has a stacking section 7 and a folding mechanism 8.

The stacking section 7 neatly stacks cut sheets Sn equivalent to a single newspaper in a stacking space of a size of two pages of a newspaper laid side by side to stack them neatly, and form a cut sheet bundle GS.

The folding mechanism 8 forms a signature SS by folding a formed cut sheet bundle GS at a central position of two pages of a newspaper laid side by side, parallel to the vertical direction of one page of the newspaper.

The cutting mechanism 5 of the cutting and folding unit 3a has a cutting section 51, a guide-in section 52 and a delivery section 53. The cutting section 51 has a cutter drum 51a and a cutter receiving drum 51b provided facing each other either side of the traveling path for the continuous web W1. The guide-in section 52 feeds a continuous web W1 after being printed, that has been fed in by the feed mechanism 14a provided at an upstream side of the cutting section 51, to the cutting section 51. A delivery section 53 is provided at a downstream side of the cutting section 51, and causes a continuous web W1 after having been cut to travel towards the down stream side.

The cutter drum 51a of the cutting section 51 is provided with at least one cutter 51d at an outer surface, and the cutter receiving drum 51b is provided with at least one cutter indent 51e at the outer surface. Both drums are respectively provided parallel to each other and parallel to the surface of the traveling continuous web W1, and capable of rotation, being driven around an axis at right angles to the travel direction of the continuous web W1, and cut the continuous web W1 to form a cut sheet Sn by meshing the cutter 51d with the cutter indent 51e by rotation. The cutter drum 51a and the cutter receiving drum 51b form the cut sheet Sn to a size of a desired number of pages laid side by side, for every cutting out of a sheet Sn, utilizing a cutting section drive source, not shown, operating under the control of control member 4, and are caused to rotate by adjusting rotational speed and rotational phase with respect to travel speed of the continuous web W1 so as to cut the continuous web W1 at blank sections between pages of the printed newspaper.

The guide-in section 52 has a guide-in upper belt section 52a and guide-in lower belt section 52b provided either side of the traveling path of the continuous web W1.

The guide-in upper belt section 52a comprises a plurality of pulley sets 52c, 52d, and 52e that are provided being capable of rotation around an axis parallel to the central axis of the drums of the cutting section 51, each having a predetermined specified number of pulleys being spaced apart spanning in the cross direction of the continuous web W1, and an endless belt set 52f with each belt in the set being wound around the associated pulleys of these pulley sets 52c, 52d, and 52e that are at the same axial direction position as each other.

The guide-in lower belt section 52b comprises a plurality of pulley sets 52g, 52h, and 52i that are provided being capable of rotation around an axis parallel to the central axis of the drums of the cutting section 51, each pulley set having a predetermined specified number of pulleys being spaced apart spanning in the cross direction of the continuous web W1 so as to be at positions aligned with the pulleys of each pulley set 52c, 52d and 52e of the guide-in upper belt section 52a, and an endless belt set 52j with each belt in the set being wound around the associated pulleys of these pulley sets 52g, 52h, and 52i that are at the same axial direction position as each other.

The pulley set 52c of the guide-in upper belt section 52a is rotatably driven by a guide-in upper belt section drive source, not shown, that is operated under the control of the control member 4, and the endless belt set 52f is rotatably displaced in an anti-clockwise direction in FIG. 5.

The pulley set 52g of the guide-in lower belt section 52b is rotatably driven by a guide-in lower belt section drive source, not shown, that is operated under the control of the control member 4, and the endless belt set 52j is rotatably displaced in a clockwise direction in FIG. 5. Specifically, each belt of the guide-in upper belt section 52a and each belt of the guide-in lower belt section 52b face each other across the traveling path of the continuous web W1, and the facing sections sandwich the continuous web W1 and move at the same relative speed and in the same relative direction.

The delivery 53 comprises a hopper belt section 53a, a delivery upper belt section 53b, and delivery lower belt section 53c provided on either side of the traveling path of the continuous web W1, a delivery roller section 53d, and a path switching section 53e for switching a traveling path for the continuous web W1.

The hopper belt section 53a comprises upstream pulley sets 53f and 53g, provided capable of rotation about an axis parallel to the axial center of the drums of the cutting section 51, with a predetermined specified number of pulleys being spaced apart from each other in a cross direction of the continuous web W1, and provided facing each other on either side of the traveling path for the continuous web W1, and downstream pulley sets 53h and 53i, provided capable of rotation about an axis parallel to the axial center of the drums of the cutting section 51, with a predetermined specified number of pulleys being spaced apart from each other, in a cross direction of the continuous web W1, so as to be at positioned aligned with the pulleys of the upstream pulley sets 53f and 53g, and provided facing each other on either side of the traveling path for the continuous web W1, and a one side endless belt set 53j which is wound around associated pulleys of the upstream pulley set 53f and the downstream pulley set 53h at one side of the traveling path of the continuous web W1 that are aligned with each other at axial direction positions, and an other side endless belt set 53k which is wound around associated pulleys of the upstream pulley set 53g and the downstream pulley set 53i at another side of the traveling path of the continuous web W1 that are aligned with each other at axial direction positions. The upstream pulley sets 53f and 53g are spaced opposite each other slightly apart.

The delivery upper belt section 53b comprises a plurality of pulley sets 53l, 53m, and 53n that are provided being capable of rotation around an axis parallel to the central axis of the drums of the cutting section 51, each having a predetermined specified number of pulleys being spaced apart spanning in the cross direction of the continuous web W1, and an endless belt set 53o with each belt in the set being wound around the associated pulleys of these pulley sets 53l, 53m, and 53n that are at the same axial direction position as each other. The delivery lower belt section 53c comprises a plurality of pulley sets 53p, 53q, and 53r that are provided being capable of rotation around an axis parallel to the central axis of the drums of the cutting section 51, each pulley set having a predetermined specified number of pulleys being spaced apart spanning in the cross direction of the continuous web W1 so as to be at positions aligned with the pulleys of each pulley set 53l, 53m and 53n of the delivery upper belt section 53b, and an endless belt set 53s with each belt in the set being wound around the associated pulleys of these pulley sets 53p, 53q, and 53r that are at the same axial direction position as each other.

The pulley set 53l of the delivery upper belt section 53b, and the downstream pulley set 53h of the hopper belt section 53a, are rotatably driven together by a delivery upper belt section drive source, not shown, provided on the same rotational axis and operated under the control of the control member 4, with the pulley set 53l rotatably displacing the endless belt set 53o in an anti-clockwise direction in FIG. 5(b), and the downstream pulley set 53h rotatably displacing one side endless belt set 53j in an anti-clockwise direction in FIG. 5(b). Also, the pulley set 53p of the delivery lower belt section 53c, and the downstream pulley set 53i of the hopper belt section 53a, are rotatably driven together by a delivery lower belt section drive source, not shown, provided on the same rotational axis and operated under control of the control member 4, with the pulley set 53p rotatably displacing the endless belt set 53s in a clockwise direction in FIG. 5(b), and the downstream pulley set 53i rotatably displacing the other side endless belt set 53k in a clockwise direction in FIG. 5(b). Specifically, each belt of the one side endless belt set 53j and the other side endless belt set 53k of the hopper belt section 53a face each other across the traveling path of the continuous web W1 and the facing sections sandwich the continuous web W1 and move at the same relative speed and in the same relative direction. Also, each belts of the endless belt set 53o of the delivery upper belt section 53b and each belt of the endless belt set 53s of the delivery lower belt section 53c face each other across the traveling path of the continuous web W1, and the facing sections sandwich the continuous web W1 and move at the same relative speed and in the same relative direction. Accordingly, each belt of the hopper belt section 53a, each belt of the delivery upper belt section 53b and each belt of the delivery lower belt section 53c have opposed sites that are movably displaced at either side of the traveling path of the continuous web W1 that are displaced at the same relative speed and in the same relative direction.

Still further, the guide in upper belt section drive source (not shown) and the guide in lower belt drive source (not shown) of the guide in section 52, together with the delivery upper belt section drive source (not shown) and the delivery lower belt section drive source (not shown) of the feed section 53, are controlled by the control member 4 so moving displacement speed of each belt is the same.

The delivery roller section 53d is formed using an upper roller section 53t and a lower roller section 53u. The upper roller section 53t has a predetermined specified number of rollers provided spaced apart spanning the cross direction of the continuous web W1, and capable of rotation around a central axis parallel to the drums of the cutting section 51. The lower roller section 53u has a predetermined specified number of rollers provided spaced apart spanning the cross direction of the continuous web W1 so as to be positioned aligned with the rollers of the upper roller section 53t, and capable of rotation around a central axis parallel to the drums of the cutting section 51. Each roller of the upper roller section 53t and each roller of the lower roller section 53u is provided at the most downstream side of the delivery section 53, so as to make gripping contact with the continuous web W1 in the traveling path.

Also, the upper roller section 53t of the delivery roller section 53d is provided to be rotatably driven in an anti-clockwise direction in FIG. 5 by the delivery upper roller section drive source (not shown), and the lower roller section 53u of the delivery roller section 53d is provided to be rotatably driven in a clockwise direction in FIG. 5(b) by the delivery lower roller section drive source (not shown). The delivery upper roller section drive source is controlled by the control member 4 so that the speed of the outer surface of each roller of the upper roller section 53t is the same speed as the speed of displacing movement of each belt of the guide-in section 52 and each belt of the delivery section 53. Also, the delivery lower roller section drive source is controlled by the control member 4 so that the speed of the outer surface of each roller of the lower roller section 53u is the same speed as the speed of displacing movement of each belt of the guide-in section 52 and each belt of the delivery section 53. Incidentally, it is also possible in the delivery roller section 53d for at least one of the upper roller section 53t and the lower roller section 53u to be provided with a single roller provided with an external surface that continuously spans the entire cross direction of the continuous web. The path switching section 53e is provided between downstream side end sections of the delivery upper belt section 53b and the delivery lower belt section 53c (in the following made the delivery belt downstream ends) and the delivery roller section 53d.

The path switching section 53e has a one side constraining member 53v and another side constraining member 53w, with the one side constraining member 53v and the other side constraining member 53w constraining at least both sides of the continuous web W1 to form a traveling path (in the following made a direct traveling path) for allowing the continuous web W1 to travel directly from the delivery belt downstream end to the delivery roller section 53d.

The one side constraining member 53v and the other side constraining member 53w are provided respectively spanning the entire continuous web W1 in the cross direction, with a first opening section and a second opening section being formed on the other side constraining section 53w, at a suitable position close to the delivery belt downstream end and at a suitable position close to the delivery roller section 53d, respectively, in a state warped in the cross direction of the continuous web W1 so that the continuous web W1 is not obstructed and is capable of passing, with a path switching member 53y capable of angular displacement about a center axis of the axis 53x a drive source (not shown) being provided on the first opening section.

At a normal time, the path switching member 53y is held in a posture parallel to the other side constraining member 53w to form part of the other constraining member 53w by blocking the first opening section, the direct traveling path is closed off together with closing off of the first opening section by rotational displacement, and is provided capable of guiding a tip section of the continuous web W1 formed by the cutting section 51 into the first opening section using the part where the direct traveling path is closed off. A start end of a pre-folding guide path 6a, which is a guide path for the continuous web in the pre-folding mechanism 6, that will be described later, is connected to the position of the first opening section, while a terminal end of a pre-folding guide passage 6a is connected to the position of the second opening section.

The pre-folding mechanism 6 of the cutting and folding unit 3a has a pre-folding guide path 6a, a leading side folding section 6b and a trailing side folding section 6c, and with the illustrated embodiment is provided below the cutting mechanism 5, and capable of linked operation with the cutting mechanism 5 by connecting the start end and terminal end of the pre-folding guide path 6a to the cutting mechanism.

The pre-folding guide path 6a is capable of respectively pre-folding to a size of 2-page width utilizing folding to fold one page at either side of a 3-page cut sheet S3 formed by the cutting mechanism 51 parallel to a vertical direction of a single newspaper page so that the one page is overlapped on a center page, and folding to fold each side page of a 4-page cut sheet S4 parallel to the vertical direction of a single newspaper page so that associated adjacent pages of the 4-page cut sheet are overlapped on each other on the same side.

The leading side folding section 6b is provided at a mid-point of the pre-folding guide path 6a, and folds a one leading side page of a 4-page cut sheet S4. The trailing side folding section 6c curves one trailing side page of the 4-page cut sheet S4.

The pre-folding guide path 6a is provided with a trunk passage 6d provided so that a 3-page cut sheet S3 and a 4-page cut sheet S4 (hereafter made a sheet that requires pre-folding) have at least both surfaces constrained and guided by the constraining member 6p, and a first branched passage 6e and a second branched passage 6f that are branched off from the trunk passage 6d. The trunk passage 6d is provided starting at the start end, leading to the terminal end by way of the leading side folding section 6b and the trailing side folding section 6c, in that order, the first branched passage 6e is provided branching from the trunk passage 6d at the position of the leading side folding section 6b, the second branched passage 6f is provided branching from the trunk passage 6d at a position of the trailing side folding section 6c, and the trunk passage 6d is provided so that a direction in which a sheet that requires pre-folding is guided is changed at each branched section where the first branched section 6e and the second branched section 6f respectively branch. Also, the trunk passage 6d, first branched passage 6e and second branched passage 6f are respectively provided with paper feed roller mechanisms 6g, 6g, . . . at appropriate positions.

The paper feed roller mechanisms 6g are provided so that sheets sent out by the delivery section 53 that require pre-folding can be guided in the pre-folding guide passage 6a at the same speed as the speed at which the delivery section 53 send them out. Specifically, a plurality of paper feed roller mechanisms 6g are provided on axes parallel to the central axis of the drums of the cutting section 51, facing each other on either side of the pre-folding guide passage 6a, so that outer surfaces facing each other on either side of the pre-folding guide passage 6a contact via the cut sheets, and on respective axes arranged at appropriate intervals in the cross direction of the sheets that requires pre-folding. The paper feed roller mechanisms 6g are provided so that a plurality of rollers arranged on at least one axis are rotatably driven together around the axis at an outer peripheral speed that is the same speed as the speed that the sheets that require pre-folding are sent out from the delivery section 53, by an appropriate drive source (not shown), and so that rollers that are not driven turn together around the axis by means of the sheets that require pre-folding.

Further, the paper feed mechanisms 6g provided in the first branched passage 6e reverse the direction of drive rotation in accordance with a folding operation of the folding blade 6h of the leading side folding section 6b that will be described later, and operate so as to discharge a sheet that requires pre-folding caught inside the first branched passage 6e, from the first branched passage 6e.

Also, the paper feed mechanisms 6g provided in the second branched passage 6f reverse the direction of drive rotation in accordance with a folding operation of the folding blade 6l of the trailing side folding section 6c that will be described later, and operate so as to discharge a sheet that requires pre-folding caught inside the second branched passage 6f, from the second branched passage 6f.

The leading side folding section 6b has a folding blade 6h and a pair of folding rollers 6i, and is provided at a section for changing the guide direction of the sheets that require pre-folding by the trunk passage 6d.

The pair of folding rollers 6i is provided with two rollers 6j and 6k. The two rollers 6j and 6k are provided with so that outer surfaces face each other on either side of the trunk passage 6d, on an end section of the trunk passage 6d after guide direction change, capable of rotation around an axis parallel to the central axis of the drums of the cutting section 51. These two rollers 6j and 6k are provided with opposed outer surfaces capable of contacting at a predetermined fixed length with the overall peripheral length made maximum via the sheets that require pre-folding, and are rotatably driven by drive means (not shown) so that the right side roller 6j in FIG. 5 rotates anti-clockwise while the left side roller 6k in FIG. 5 rotates clockwise, with an outer surface speed being the same as that of the roller respective paper feed roller mechanisms 6g.

The folding blade 6h is driven by drive means (not shown) having operation timing controlled by control member 4, and carries out an insertion folding operation between the rollers 6j and 6k of the pair of folding rollers 6i at predetermined places of the sheets that require pre-folding whose leading ends have been guided past the position of the pair of folding rollers 6i and into the first branched passage 6e.

The trailing side folding section 6c has a folding blade 6l and a pair of folding rollers 6m, and is provided at a section for changing the guide direction of the sheets that require pre-folding by the trunk passage 6d, the section being at a more downstream side than the leading side folding section 6b.

The pair of folding rollers 6m is provided with two rollers 6n and 6o. The two rollers 6n and 6o are provided so that outer surfaces face each other on either side of the trunk passage 6d, on an end section of the trunk passage 6d after guide direction change, capable of rotation around an axis parallel to the central axis of the drums of the cutting section 51. These two rollers 6n and 6o are provided with opposed outer surfaces capable of contacting at a predetermined fixed length with the overall peripheral length made maximum via the sheets that require pre-folding, and are rotatably driven by drive means (not shown) so that the right upper side roller 6n in FIG. 5(b) rotates anti-clockwise while the left lower side roller 6o in FIG. 5(b) rotates clockwise, with an outer surface speed being the same as that of the paper feed roller mechanisms 6g.

The folding blade plate 6l is driven by drive means (not shown) having operation timing controlled by control member 4, and carries out an insertion folding operation between the rollers 6n and 6o of the pair of folding rollers 6m at predetermined places of the sheets that require pre-folding whose leading ends have been guided past the position of the pair of folding rollers 6m and into the second branched passage 6f.

Regarding the length and timing at which the rollers 6j and 6k of the pair of folding rollers 6i make contact via the sheets that require pre-folding, it is sufficient to be able to score the sheets that require pre-folding and have been inserted by the folding blade 6h between the two rollers 6j and 6k, and regarding the length and timing at which the rollers 6n and 6o of the pair of folding rollers 6m make contact via the sheets that require pre-folding, it is sufficient to be able to score the sheets that require pre-folding and have been inserted by the folding blade 6l between the two rollers 6n and 6o. Also, the one side constraining member 53v, other side constraining member 53w and path switching member 53y of the path switching section 53e of the cutting mechanism 5, and the constraining member 6p of the pre-folding guide passage 6a of the pre-folding mechanism 6, are not limited to the form of a plate shape or duckboard etc., as long as it is possible to constrain the traveling path or the guide passages, and the material is also not limiting as long as the configuration is stable. Taking into consideration the need to make the travel and guiding smooth, however, it is desirable for at least sections constraining the traveling path of the guide passage to be of a material and configuration having low coefficient of friction.

The folding unit 3b, being the processing unit 3, has a stacking section 7 and a folding mechanism 8. The stacking section 7 receives cut sheets Sn equivalent to a single newspaper and stack them neatly to form a cut sheet bundle GS. The folding mechanism 8 forms a signature SS by folding a formed cut sheet bundle GS at a central position of two pages of a newspaper laid side by side, parallel to the vertical direction of one page of the newspaper.

The stacking section 7 is provided with an ejection roller section 7a, a stacking space 7b and a sheet bundle delivery mechanism 7c. The stacking space 7b is inclined with a side close to the cutting and folding unit 3a higher up. The ejection roller section 7a receives cut sheets Sn that have been delivered from the cutting and folding unit 3a, and ejects them into the stacking space 7b. The sheet set delivery mechanism 7c delivers cut sheet bundle GS formed by stacking the cut sheets Sn inside the stacking space 7b.

The ejection roller section 7a has an upper roller section 7d and a lower roller section 7e, and the upper roller section 7d and the lower roller section 7e are respectively provided close to the two rollers of the delivery roller section 53d of the cutting and folding unit 3a. The upper roller section 7d and the lower roller section 7e respectively have a predetermined specified number of rollers provided spaced apart spanning the cross direction of the cut sheet Sn, at positions aligned with each other, and capable of rotation around an axis parallel to the drums of the cutting section 51. Each roller of the upper roller section 7d and each roller of the lower roller section 7e is provided at the most upstream side of the stacking section 7 so as make contact with and grip the cut sheets that have been delivered from the delivery roller section 53d of the cutting and folding unit 3a.

The upper roller section 7d of the ejection roller section 7a is provided so as to be rotatably driven in an anti-clockwise direction in FIG. 2 by an ejection upper roller drive source (not shown).

The lower roller section 7e of the ejection roller section 7a is provided so as to be rotatably driven in a clockwise direction in FIG. 2 by an ejection lower roller drive source (not shown).

The ejection upper roller section drive source (not shown) is controlled by the control member 4 so that the outer peripheral surface speed of each roller of the upper roller section 7d becomes the same speed as the speed of the rotating peripheral surfaces of the two rollers of the delivery roller section 53d, and the ejection lower roller section drive source is controlled by the control member 4 so that the outer peripheral surface speed of each roller of the lower roller section 7e becomes the same speed as the speed of the rotating peripheral surfaces of the two rollers of the delivery roller section 53d. Incidentally, it is also possible in the ejection roller section 7a for at least one of the upper roller section 7d and the lower roller section 7e to be provided with a single roller provided with an outer surface that continuously spans the entire cross direction of the ejected cut sheets Sn sheet.

The stacking space 7b is provided with 4-sides constrained to substantially the same size as a 2-page cut sheet S2 and inclined with an upstream side closer to the cutting and folding unit 3a higher up, with the two sides being the upstream side and the downstream side, in the ejection direction of the cut sheets Sn, of the constrained sides of the stacking space 7b, being defined by a delivery member 7g of the sheet bundle delivery mechanism 7c, and the other two sides being defined by appropriate means. The stacking space 7b has a receiving member 7f, and the receiving member 7f receives cut sheets Sn ejected from the ejection roller section 7a on an upper surface, that upper surface being formed from a material having a comparatively low coefficient of friction. A plurality of gaps, that the delivery member 7g is capable of passing through when moving from the upstream side to the downstream side of the stacking space 7b in order to carry out a delivery operation, are provided in the receiving member 7f, having appropriate intervals in a direction at right angles to the movement direction of the delivery member 7g.

The sheet bundle feed mechanism 7c is comprised of four sprocket wheels 7h, 7i, 7j and 7k having the same diameter, an endless chain 7l, an endless chain 7m, support members (not shown) attached at four places, and the delivery member 7g. The four sprocket wheels 7h, 7i, 7j and 7k are provided in the four lower corners of the stacking space 7b, capable of rotation about an axis parallel to the central axis of the drums of the cutting section 51, and aligned with two axial direction positions at the upstream side and the downstream side of the stacking space 7b. The endless chain 7l is wound between the upstream side sprocket wheel 7h and the downstream side sprocket wheel 7j of sprocket wheels 7h, 7i, 7j, and 7k whose axial direction positions are adjusted. The endless chain 7m is similarly wound around the upstream side sprocket wheel 7i and the downstream side sprocket wheel 7k. Support members (not shown) are attached at four places so as to be parallel to the center axis of the drums of the cutting section 51 between the endless chain 7l and the endless chain 7m. The delivery member 7g is attached to the support members at a predetermined spacing.

An interval between the rotational axes of the upstream side sprocket wheels 7h and 7i, and the downstream side sprocket wheels 7j and 7k, is provided as a length A plus a that is twice the length of the cross direction dimension of one page of a newspaper, plus α, and an interval between attachment of the support members attached at four places between the endless belt 7l and the endless belt 7m is set as the length A plus α, the length of a semicircular arc of a pitch circle of the sprocket wheels, length A plus α, and the length of a semicircular arc of a pitch circle of the sprocket wheels. Specifically, in a state where an attachment interval of the support members is length A plus α and the delivery member 7g constrains two sides, namely the upstream side and the downstream side, of the stacking space 7b, the delivery member 7g attached to the support members awaits formation of a cut sheet bundle GS by stacking up the cut sheets on the receiving member 7f, and if the cut sheet bundle GS has been formed the endless chain 7l and the endless chain 7m are displaced in accordance with clockwise displacement in FIG. 2 by half their length, that is, by a length corresponding to a total of the length A plus α and a semicircular length of a pitch circle of the sprocket wheels, and the cut sheet bundle GS on the receiving member 7f is delivered to the folding mechanism 8.

The folding mechanism 8 comprises an upper plate 8a, a conveyor section 8b, a stopper 8c, a folding roller pair 8d, and a folding blade 8e. The upper plate 8a receives and supports a cut sheet bundle GS delivered from the stacking section 7, and the conveyor section 8b moves the cut sheet bundle GS delivered from the stacking section 7 onto the upper plate 8a. The stopper 8c limits movement if the cut sheet bundle GS on the upper plate 8a. The folding roller pair 8d is provided below the upper plate 8a, and the folding blade 8e is provided above the upper plate 8a capable of reciprocal movement between a standby position, separated from the upper plate by a distance that is greater than the thickness of at least a cut sheet bundle GS, and an operating position where the tip end of the folding blade 8e reaches between the rollers of the folding roller pair 8d.

The upper plate 8a is divided in two by an opening section provided substantially in the center, in the movement direction of the cut sheet bundle GS by the conveyor section 8b. An opening section at right angles to the movement direction of the cut sheet bundle GS enables the folding blade 8e to be moved towards the operating position. The opening section has a width capable of passing a cut sheet bundle GS in a folded in two state when the cut sheet bundle GS positioned over the opening section is inserted between the rollers of the folding roller pair 8d, and the two edges of the opening section are formed in a smoothly curving shape so that passage of the cut sheet bundle GS is not obstructed.

The conveyor section 8b is divided by at least the opening position of the upper plate 8a, and has an upstream conveyor section 8f and a downstream conveyor section 8j. The upstream conveyor section 8f is provided with two pulley sets 8g and 8h comprising a plurality of pulleys provided capable of rotation about a central axis parallel to the center axis of the drums of the cutting section 51 and with positions aligned at appropriate intervals in the center axis direction, and an endless belt set 8i wound around associated pulleys of the two pulley sets with aligned positions, and the down stream conveyor section 8j is provided with two pulley sets 8k and 8l comprising a plurality of pulleys provided capable of rotation about a central axis parallel to the center axis of the drums of the cutting section 51 and with positions aligned at appropriate intervals in the center axis direction, and an endless belt set 8m wound around associated pulleys of the two pulley sets with aligned positions.

The endless belt set 8i and the endless belt set 8m are provided so that an upper side displacement section is displaced along the upper surface of the upper plate 8a.

The stopper 8c is provided on the upper surface of the upper plate 8a, and is provided capable of stopping a cut sheet bundle GS that has been conveyed by the conveyor section 8b with a central section in the conveyance direction thereof in alignment with the opening section of the upper plate 8a. Also, part of a lower surface is notched so that the endless belt set 8m is capable of passing through.

The folding roller pair 8d has two opposed folding rollers 8n and 8o, and these two opposed folding rollers 8n and 8o are driven by a drive source (not shown) to be capable of rotation about an axis parallel to the center axis of the drums of the cutting section 51, are face each other with a slight gap between them. These two folding rollers 8n and 8o are close to the underneath of the upper plate 8a, and are provided so that a center of an opposed gap of the folding rollers 8n and 8o becomes substantially directly below a center of the opening section of the upper plate 8a. An opposed space of the two folding rollers 8n and 8o is a space capable of firmly folding a cut sheet bundle in two to form a cut sheet bundle GS into a signature SS having a size of one newspaper page when the folding plate 8e is moved towards the operating position to insert the cut sheet bundle GS on the upper plate 8a between the two rollers, and is provided cable of being made wider or narrower by moving at least one of the rollers backwards and forwards relative to the other roller using adjustment means, not shown. The speed of the peripheries of the folding rollers 8n and 8o can be a speed that achieves completion of the folding processing of the leading cut sheet bundle GS before the trailing cut sheet bundle GS is delivered from the stacking section 7.

The folding bundle 8e is provided, for example, linked to a drive source (not shown) by a link mechanism (not shown), and is provided capable of reciprocation between a standby position, separated from the upper plate by a distance that is greater than the thickness of at least a cut sheet bundle GS, and an operating position where the tip end of the folding blade 8e reaches between the rollers of the folding roller pair 8d, by operation of the drive source. Specifically, the folding blade 8e operates so that when a central part, in a conveyance direction, of a cut sheet bundle GS that has been conveyed onto the upper plate 8a by the conveyance section 8b has been adjusted to align with the opening section of the upper plate 8a, the insertion tip end of the folding blade 8e is brought into contact with the upper surface of the cut sheet bundle GS, and the cut sheet blade GS is pressed through the opening section of the upper plate 8a and in between the folding rollers 8n an 8o, by operation of a drive source whose operation timing has been adjusted by the control member 4. In the folding unit 52, reference numeral 8q is a take out section for taking out the signature SS that has been folded by the folding mechanism 8, and 8p is a guide member for guiding the signature SS that has been folded by the folding mechanism 8 to the take out section 8q.

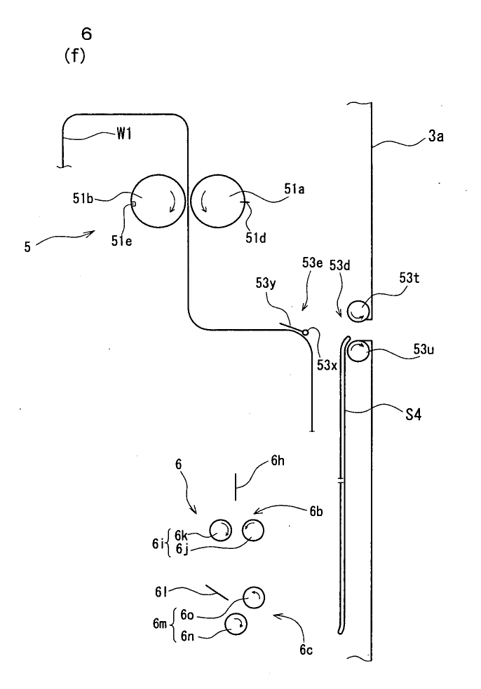

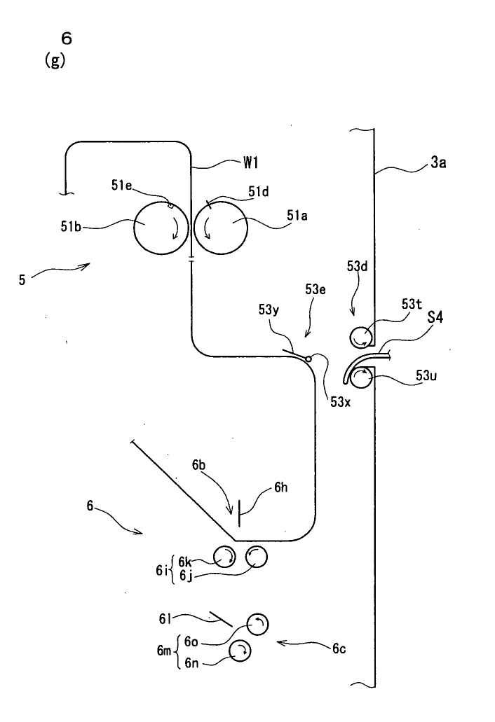

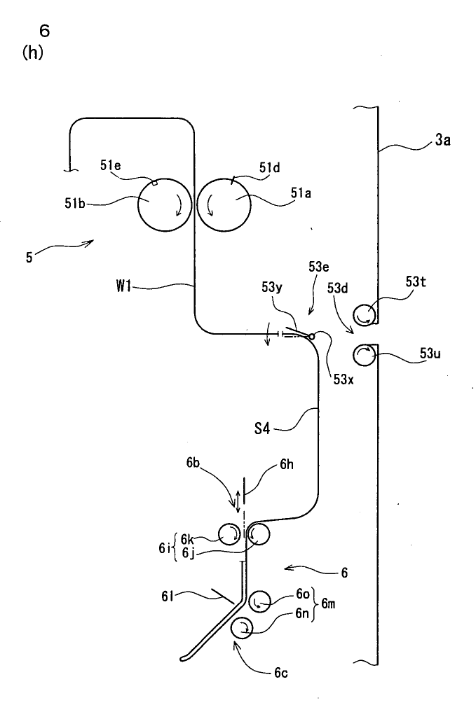

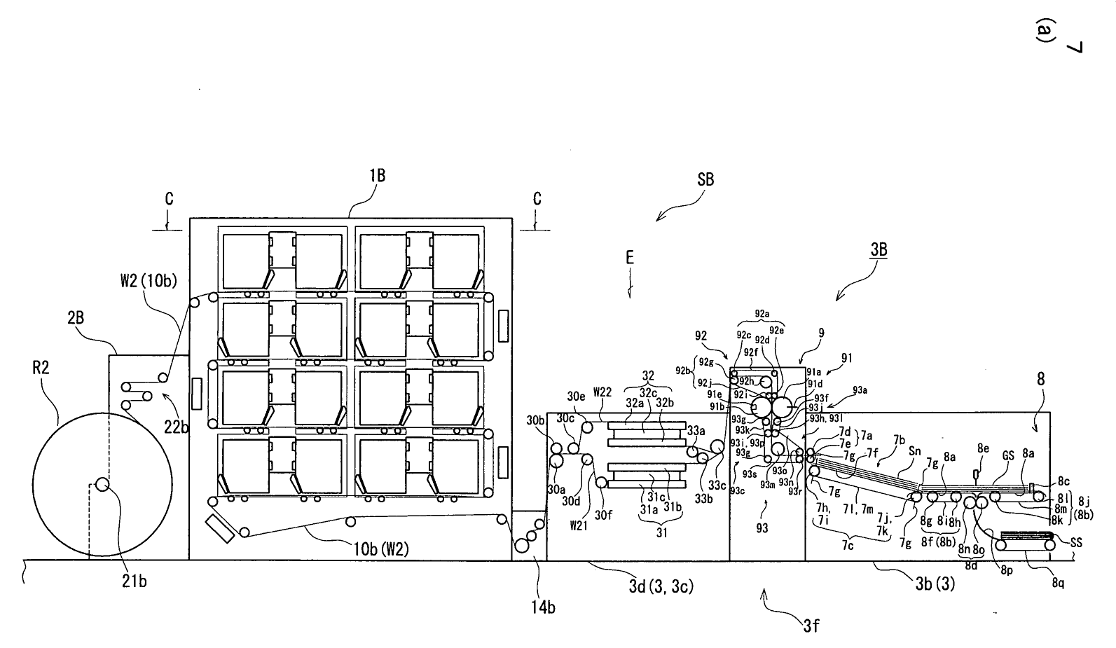

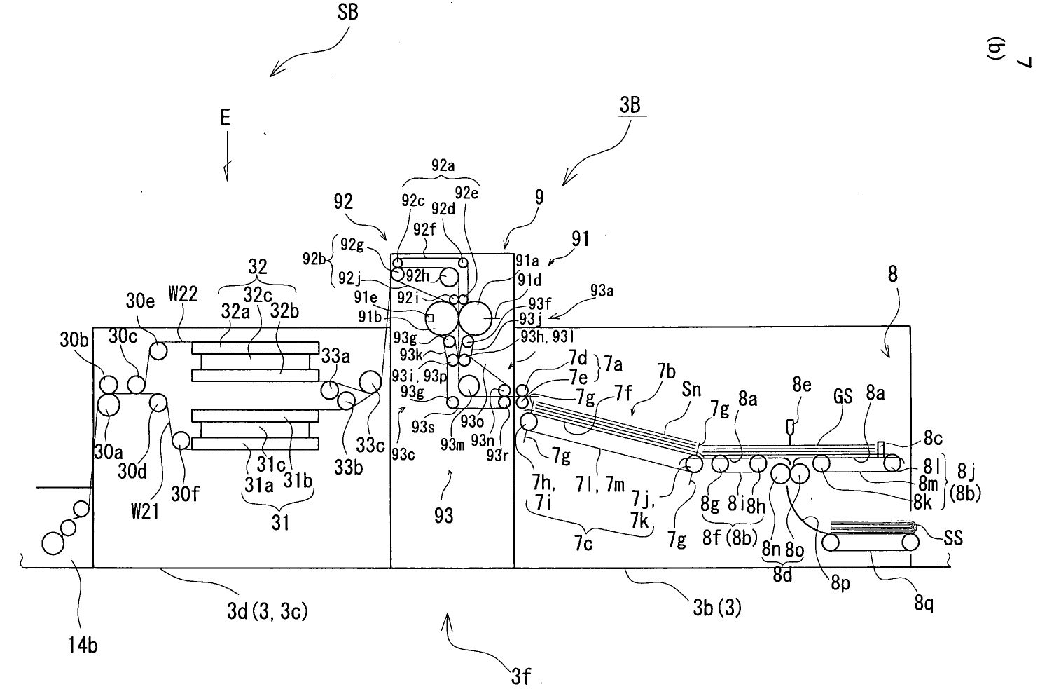

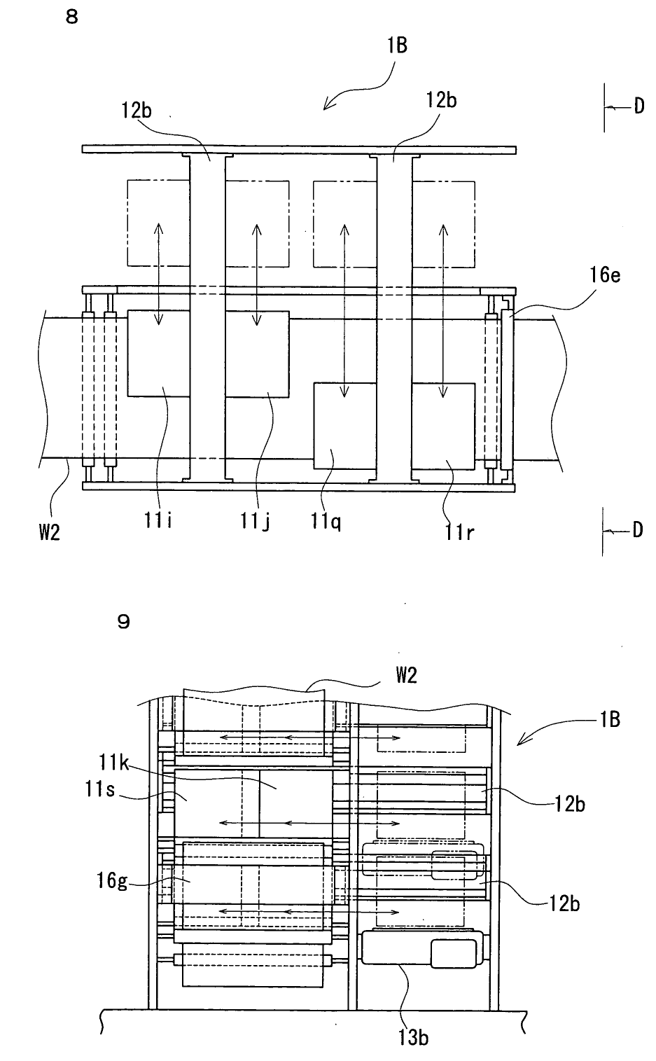

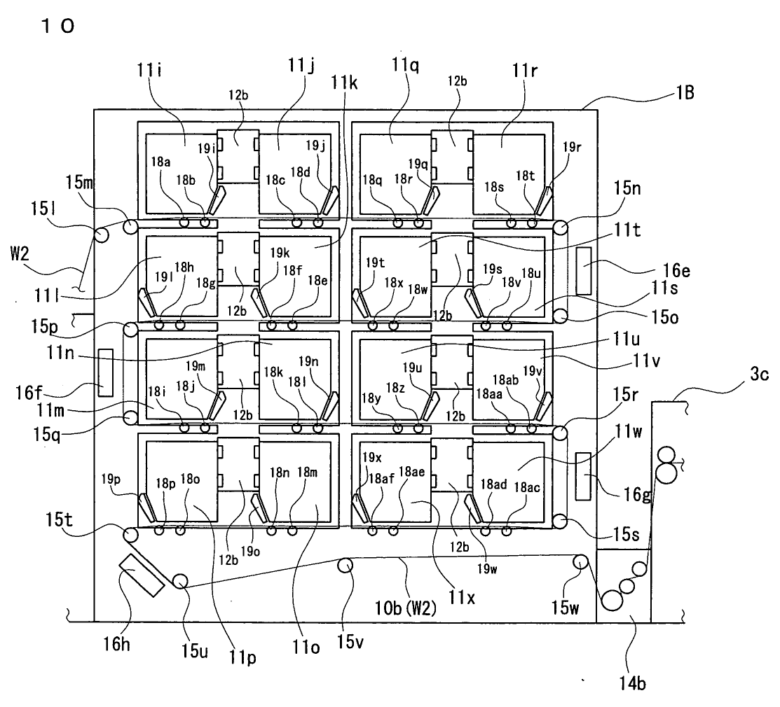

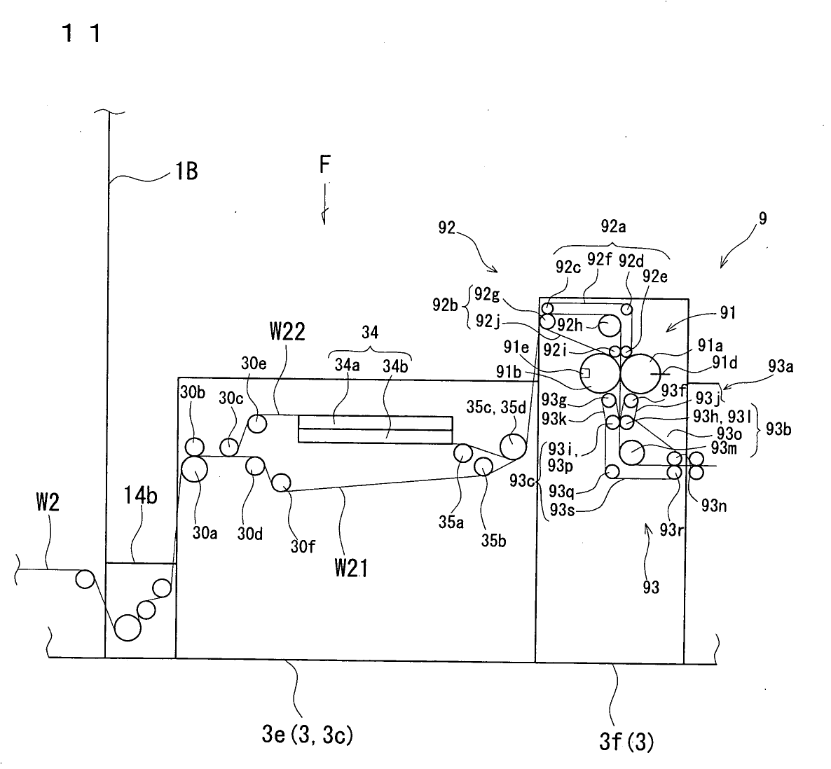

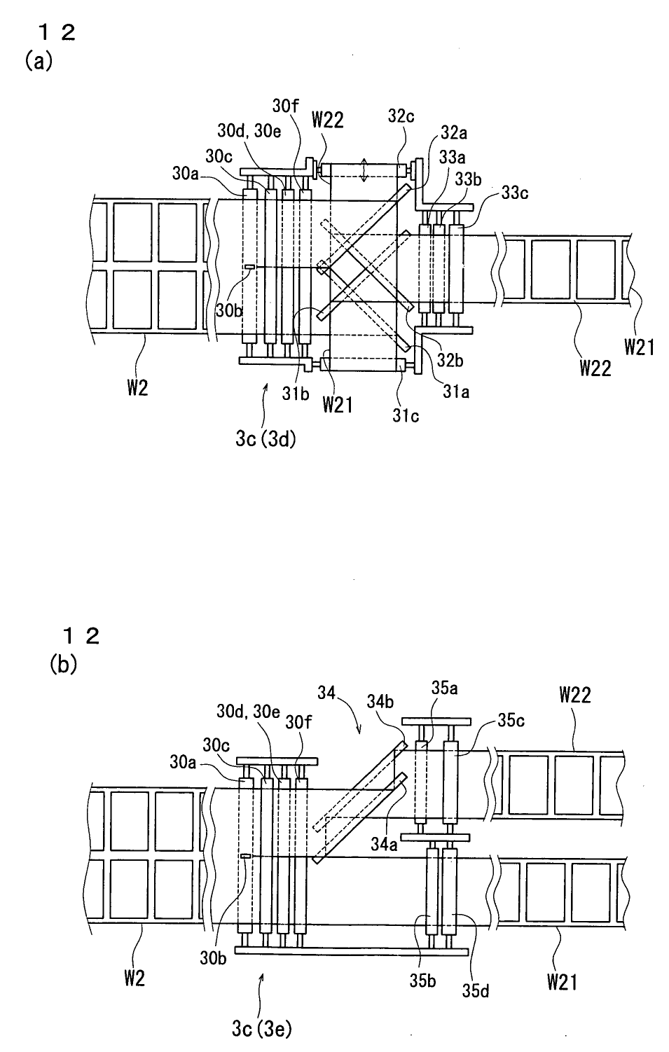

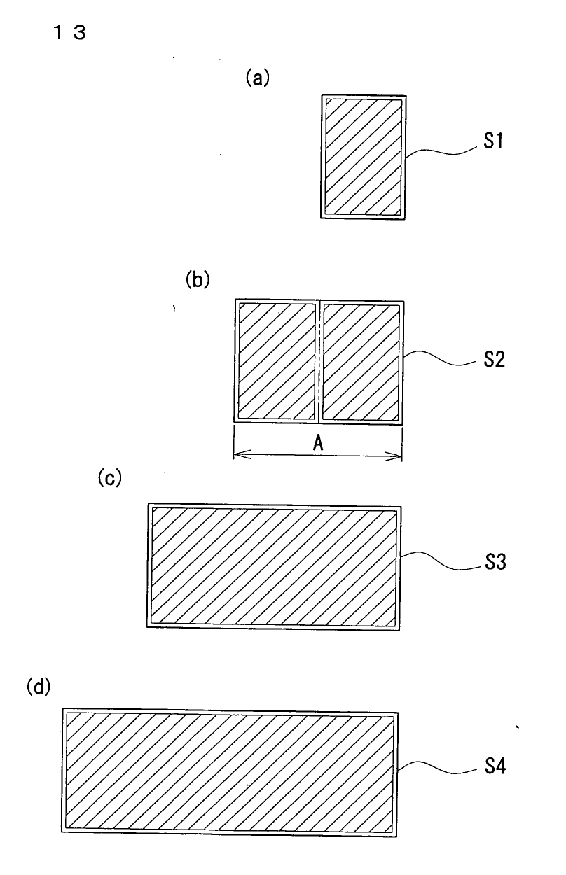

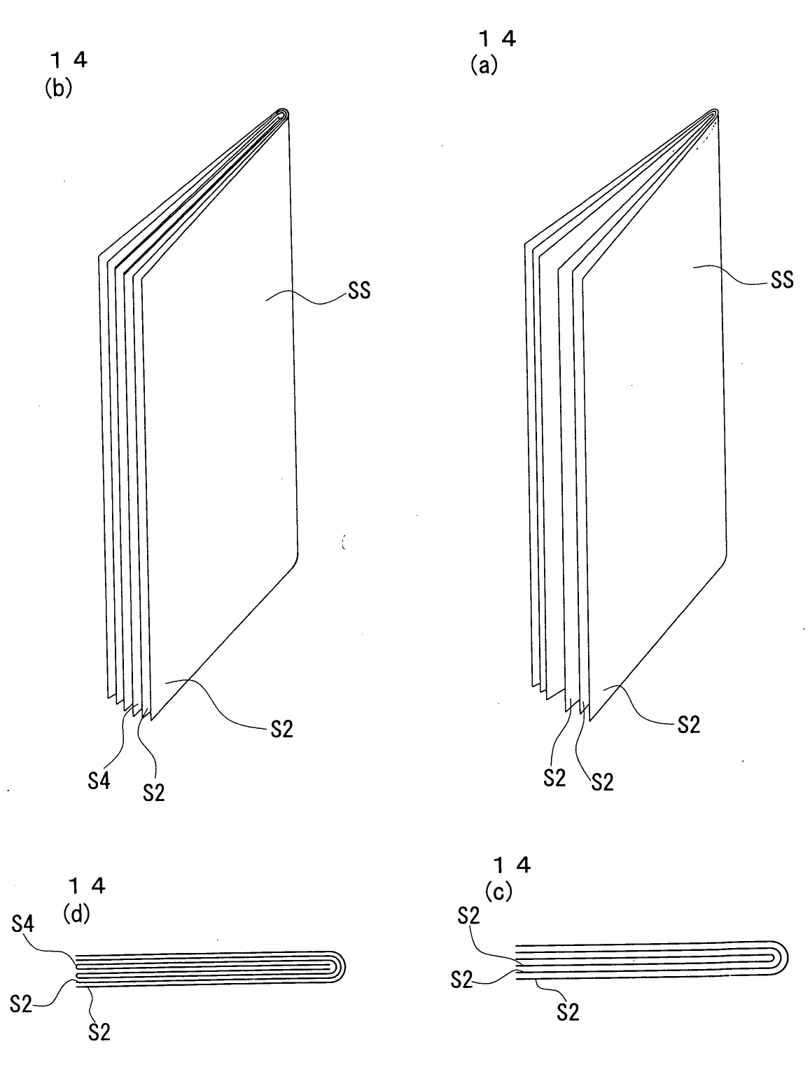

A newspaper production system SB that is a second embodiment shown in FIG. 7(a), FIG. 7(b), FIG. 8, FIG. 9, FIG. 10, FIG. 11, FIG. 12(a) and FIG. 12(b) has a continuous web supply unit 2B provided at an upstream side of a printing unit for printing on one surface and the other surface of a continuous web 1B, and has a divided continuous web course changing unit 3c (overlapping unit 3d or separating unit 3e), being a processing unit 3B, a cutting unit 3f, and a folding unit 3b provided at a downstream side of the printing unit for printing on one surface and the other surface of a continuous web 1B. A overlapping unit 3d, being an embodiment D of the divided continuous web course changing unit 3c, is shown in FIG. 7(a) FIG. 7(b) and FIG. 12(a), while a separating unit 3e, being an embodiment E of the divided continuous web course changing unit 3c, is shown in FIG. 11 and FIG. 12(b).

The continuous web supply unit 2B is provided capable of supplying a continuous web W2 having a paper width conforming to two pages of a vertical dimension of a newspaper to the printing unit for printing on one surface and the other surface of a continuous web 1B.

The divided continuous web course changing unit 3c (overlapping unit 3d or separating unit 3e) divides the continuous web W2 after printing in two by slitting in the longitudinal direction, and delivers the divided continuous web to a cutting unit 3f provided at the downstream side. With the embodiment where the divided continuous web course changing unit 3c is an overlapping unit 3d, it is possible for two divided continuous webs that have been divided to be overlapped and delivered to the cutting unit 3f that is provided at a downstream side.

With the embodiment where the divided continuous web course changing unit 3c is a separating unit 3e, it is possible for two divided continuous webs that have been divided to be separated and individually delivered to the cutting unit 3f that is provided at a downstream side.

The printing unit for printing on one surface and the other surface of a continuous web 1B has ink jet printing devices 11i to 11x, having ink jet print heads (not shown) provided with a plurality of ink discharge ports spanning a dimension that is larger than the vertical direction dimension of one page of a newspaper, provided at four vertical levels, with four in each level, that is, arranged two on one side half and two on the other side half in the cross direction of the continuous web W2 corresponding to each half, so that it is possible to respectively print a region corresponding to the vertical dimension of one page of a newspaper, as shown in enlarged form in FIG. 10.

Each of the ink jet printing devices 11i to 11x is provided so as to having ink discharge openings facing downwards, and at a printing position so that central positions in the cross direction of each ink jet printing devices 11i to 11p corresponding to the one side half in the cross direction of the continuous web W2 are on substantially the same plane, while central positions in the cross direction of each ink jet printing devices 11q to 11x corresponding to the other side half in the cross direction of the continuous web W2 are on substantially the same plane, but different from the plane for the ink jet printing devices 11i to 11p. For example, the printing devices 11i to 11x are provided so that using a lateral movement unit 12b provided with a screw feeding mechanism (not shown), fine movement for lateral register adjustment of the printing image, and large movement between the printing position and a maintenance position (shown by the dashed double-dotted line in FIG. 8 and FIG. 9) for performing maintenance of the ink jet print heads after printing using a maintenance unit 13b, is possible.

Also, a plurality of guide rollers 15l to 15w forming a paper run-through path 10b are provided in the printing unit for printing on one surface and the other surface of a continuous web 1B, below the ink jet printing devices 11j to 11x of each stage, that is, below the ink jet print heads of each stage, so that the continuous web W2 is capable of running sequentially through from the upper stage to the lower stage in a zigzag fashion. Drying units 16e to 16h are provided respectively facing the paper run-through passages 10b spanning between after the paper has passed below the ink jet print heads of the upper stage and below the ink jet print heads of the next stage, and facing the run-through passage 10b after running below the ink jet print heads of the lowest stage. In FIG. 10, reference numerals 18a to 18z and 18aa to 18af are back-up rollers, 19i to 19x are suction devices for collecting ink mist that files off at the time of printing, and 14b is a feed mechanism for feeding the continuous web W2 to the downstream side.

The continuous web supply unit 2B has a support section 21b capable of braking rotation of a continuous web roll R2 of the continuous web W2 of a width conforming to the vertical dimension of two pages of a newspaper, and a tension detecting section 22b that is displaced in an oscillating fashion according to traveling tension of the continuous web W2, and the tension detection section 22b is provided so that strength of a braking force for braking rotation of the continuous web roll R2 can be automatically adjusted according to the magnitude of detected traveling force of the continuous web W2.

The continuous web supply unit 2B is also provided with a continuous web roll lifting mechanism (not shown) for lifting the continuous web roll R2 at the time of loading the continuous web roll R2 into the support section 21b. The continuous web roll lifting mechanism is formed from a link mechanism that has a hydraulic cylinder, for example, as a drive source.

A divided continuous web course changing unit 3c, being the processing unit 3B, is provided at a downstream side of the printing unit for printing on one surface and the other surface of a continuous web 1B. The divided continuous web course changing unit 3c exists as an embodiment D, being a overlapping unit 3d for changing the course of two divided continuous webs W21 and W22 so as to overlap the divided continuous webs W21 and W22, and an embodiment E, being a separation unit 3e for changing the course of two divided continuous webs W21 and W22 so as to separate the divided continuous webs W21 and W22.

Embodiment D, where the divided continuous web course changing unit 3c is the overlapping unit 3d, is shown in FIG. 7(b) and FIG. 12(a).

The overlapping unit 3d is comprised of a drag roller 30a, a slitter 30b, guide roller 30c, 30d, 30e and 30f, guide roller 33a and 33b, and a delivery roller 33c.

The drag roller 30a is driven to rotate by a not shown drive source, and draws in a continuous web W2 that has been printed by the printing unit for printing on one surface and the other surface of a continuous web 1B and fed by the feed mechanism 14b. The slitter 30b forms two divided continuous webs W21 and W22 of a width conforming to the vertical dimension of one newspaper page by cutting the continuous web W2 that has been drawn in by the drag roller 30a at the center in the cross direction, parallel to the longitudinal direction, on the drag roller 30a. The guide roller 30c, 30d, 30e and 30f respectively guide the divided continuous web W21 to a turn bar section 31, and the divided continuous web W22 to a turn bar section 32. The guide rollers 33a and 33b overlap the divided continuous webs W21 and W22 whose course has been changed by the turn bar sections 31 and 32 at a central part in the cross direction of the overlapping unit 3d, and guide them towards the downstream side cutting unit 3f. The delivery roller 33c is driven by a not shown drive source, and delivers the overlapped continuous webs W21 and W22 to a downstream side.

The turn bar section 31 is provided with an upstream turn bar 31a and a downstream turn bar 31b for changing the traveling direction of the divided continuous web W21 in a state parallel to the paper surface through 90 degrees, and a guide roller 31c, provided between the two turn bars, changing the travel direction of the divided continuous web W21 that has passed the upstream turn bar 31a by 180 degrees, and guiding towards the downstream turn bar 31b. The upstream turn bar 31a and the downstream turn bar 31b are provided in a mechanical relationship at right angles to each, as shown in FIG. 12(a). The turn bar section 32 is provided with an upstream turn bar 32a and a downstream turn bar 32b for changing the traveling direction of the divided continuous web W22 by 90 degrees in a state parallel to the paper surface, and a guide roller 32c, provided between the two turn bars, for changing the travel direction of the divided continuous web W22 that has passed the upstream turn bar 32a by 180 degrees, and guiding towards the downstream turn bar 32b. The turn bar section 32 is further provided with a traveling path length adjustment section (not shown) for adjusting the traveling path length for the divided continuous web W22 by moving a position of the guide roller 32c parallel to the travel direction of the divided continuous web W22 traveling towards the guide roller 32 (direction shown by arrows in FIG. 12(a)), so that page positions of the newspaper are aligned with each other when the two divided continuous webs W21 and W22 are overlapped. The upstream turn bar 32a and the downstream turn bar 32b are provided in a mechanical relationship at right angles to each, as shown in FIG. 12(a).

Embodiment E, where the divided continuous web course changing unit 3c is the separating unit 3e, is shown in FIG. 11 and FIG. 12(b).

The separating unit 3e is comprised of a drag roller 30a, a slitter 30b, guide rollers 30c, 30d, 30e and 30f, guide rollers 35a and 35b, and delivery rollers 35c and 35d.

The drag roller 30a is driven to rotate by a not shown drive source, and draws in a continuous web W2 that has been printed by the printing unit for printing on one surface and the other surface of a continuous web 1B and fed by the feed mechanism 14b. The slitter 30b forms two divided continuous webs W21 and W22 of a width conforming to the vertical dimension of one newspaper page by cutting the continuous web W2 that has been drawn in by the drag roller 30a at the center in the cross direction, parallel to the longitudinal direction, on the drag roller 30a.

The guide rollers 30c, 30d, 30e and 30f respectively guide the divided continuous web W21 as is to a downstream side guide roller 35b, and guide the divided continuous web W22 to a turn bar section 34. The guide roller 35b guides the divided continuous web W21 that travels straight on after cutting by the slitter 30b towards the downstream cutting unit 3f. The guide roller 35a guides the divided continuous web W22 that has had its course changed by the turn bar section 34 and travels parallel to the divided continuous web W21, towards a separate downstream side cutting unit 3f that is provided alongside the cutting unit 3f that the divided continuous web W21 has been guided to, so as to separate the divided continuous web W22 from the divided continuous web W21 traveling straight to 35b after being cut. The delivery roller 35d is driven by a not shown drive source, and delivers the divided continuous web W21 to a downstream side, while the delivery roller 35c is driven by a not shown drive source and delivers the divided continuous web W22 to a downstream side.

The turn bar section 34 is provided with an upstream turn bar 34a and a downstream turn bar 34b for changing the travel direction of the divided continuous web W22 through 90 degrees in a state parallel to the paper surface. The upstream turn bar 34a and the downstream turn bar 34b are provided in a mechanical relationship at parallel to each other, as shown in FIG. 12(b). The cutting unit 3f that is downstream of the separating unit 3e, and the folding unit 3b provided at the downstream side of the cutting unit 3f, are provided respectively corresponding to either the divided continuous web W21 or the divided continuous web W22. It is also sufficient for the cutting unit 3f that is downstream of the separating unit 3e to be the cutting and folding unit 3a described in relation to the printing unit for printing on one surface and the other surface of a continuous web 1A.

The cutting unit 3f has a cutting mechanism 9 as shown in FIG. 7(b) and FIG. 11. The cutting mechanism 9 is capable of cutting the divided continuous webs W21 and W22 that have been printed by the printing unit for printing on one surface and the other surface of a continuous web 1B and divided by the overlapping unit 3d or the separating unit 3e, being the divided continuous web course changing unit 3c, and of forming cut sheets Sn of a size of number of newspaper pages laid side by side, namely, for example, a 1-page cut sheet S1 or a 2-page cut sheet S2. The folding unit 3b provided at a downstream side of the cutting unit 3f is the same as the folding unit 3b described in connection with the printing unit for printing on one surface and the other surface of a continuous web 1A.

The cutting mechanism 9 of the cutting unit 3f has a cutting section 91, a guide-in section 92, and a delivery feed section 93. The cutting section 91 has a cutter drum 91a and a cutter receiving drum 91b provided facing each other either side of a traveling path for either one or both of the divided continuous webs W21 and W21 (hereafter referred to as the divided continuous web W21 and/or W22). The guide-in section 92 is provided at an upstream side of the cutting section 91, and allows the divided continuous web W21 and/or W22 that have been delivered from the overlapped unit 3d or the separating unit 3e, being the divided continuous web course changing unit 3c, to travel towards the cutting section 91. The delivery section 93 is provided at a downstream side of the cutting section 91 and delivers the divided continuous web W21 and/or W22 after cutting that have been delivered from the cutting section 91 to a downstream side.

The cutter drum 91a of the cutting section 91 is provided with at least one cutter 91d at an outer surface, and the cutter receiving drum 91b is provided with at least one cutter indent 91e at the outer surface. Both drums are provided parallel to each other, parallel to the plane of the traveling continuous web W21 and/or W22, and capable of rotation, being driven around an axis at right angles to the direction of travel of the divided continuous web W21 and/or W22, and cut paper sheets Sn, namely 1-page cut sheets S1 and 2-page cut paper sheets S2, are formed by cutting the divided continuous web W21 and/or W22 traveling between the two drums by meshing the cutter 91d and the cutter indent 91e as a result of rotation. The cutter drum 91a and the cutter receiving drum 91b form the cut sheet Sn to a size of one page or to the size of two pages laid side by side, for every cutting out of a sheet Sn, utilizing a cutting section drive source (not shown) operating under the control of control member 4, and are caused to rotate by adjusting rotational speed and rotational phase with respect to travel speed of the divided continuous web W21 and/or W22 so as to cut the divided continuous web W21 and/or W22 at blank sections between pages of the printed newspaper.

The guide-in section 92 has a guide-in upper belt section 92a and guide-in lower belt section 92b provided either side of the traveling path of the divided continuous web W21 and/or W22.

The guide-in upper belt section 92a comprises a plurality of pulley sets 92c, 92d, and 92e that are provided being capable of rotation around an axis parallel to the central axis of the drums of the cutting section 91, each having a predetermined specified number of pulleys being spaced apart spanning in the cross direction of the divided continuous web W21 and/or W22, and an endless belt set 92f with each belt in the set being wound around the associated pulleys of these pulley sets 92c, 92d, and 92e that are at the same axial direction position as each other. The guide-in lower belt section 92b comprises a plurality of pulley sets 92g, 92h, and 92i that are provided being capable of rotation around an axis parallel to the central axis of the drums of the cutting section 91, each pulley set having a predetermined specified number of pulleys being spaced apart spanning in the cross direction of the divided continuous web W21 and/or W22 so as to be at positions aligned with the pulleys of each pulley set 92c, 92d and 92e of the guide-in upper belt section 92a, and an endless belt set 92j with each belt in the set being wound around the associated pulleys of these pulley sets 92g, 92h, and 92i that are at the same axial direction position as each other. The pulley set 92c of the guide-in upper belt section 92a is rotatably driven by a guide-in upper belt section drive source (not shown) that is operated under the control of the control member 4, and the endless belt set 92f is rotatably displayed in an anti-clockwise direction in FIG. 7(b). The pulley set 92g of the guide-in lower belt section 92b is rotatably driven by a guide-in lower belt section drive source (not shown) that is operated under the control of the control member 4, and the endless belt set 92j is rotatably displayed in a clockwise direction in FIG. 7(b). Specifically, each belt of the guide-in upper belt section 92a and each belt of the guide-in lower belt section 92b face each other across the traveling path of the divided continuous web W21 and/or W22, and the facing sections sandwich the divided continuous web W21 and/or W22 and move at the same relative speed and in the same relative direction.

The delivery section 93 comprises a hopper belt section 93a, a delivery upper belt section 93b and a delivery lower belt section 93c provided either side of the traveling path of the divided continuous web W21 and/or W22.

The hopper belt section 93a comprises upstream pulley sets 93f, 93g, downstream pulley sets 93h and 93i, an one side endless belt set 93j and another side endless belt set 93k.

The upstream pulley sets 93f and 93g are provided with a predetermined specified number of pulleys at intervals spanning in the cross direction of the divided continuous web W21 and/or W22, and capable of rotation around a center axis parallel to the center axis of the drums of the cutting section 91, and are provided facing each other across the traveling path of the divided continuous web W21 and/or W22.

The downstream pulley sets 93h and 93i are provided with a predetermined specified number of pulleys at intervals spanning in the cross direction of the divided continuous web W21 and/or W22 so as to be at positioned aligned with the pulleys of the upstream pulley sets 93f and 93g, and capable of rotation around a center axis parallel to the center axis of the drums of the cutting section 91, and are provided facing each other across the traveling path of the divided continuous web W21 and/or W22.

The one side endless belt set 93j is wound around associated pulleys of the upstream pulley set 93f and the downstream pulley set 93h, of one side of the traveling path of the divided continuous web W21 and/or W22, that are aligned with each other in the axial direction. The other side endless belt set 93k is wound around associated pulleys of the upstream pulley set 93g and the downstream pulley set 93i, of the other side of the traveling path of the divided continuous web W21 and/or W22, that are aligned with each other in the axial direction. The upstream pulley sets 93f and 93g are opposite to each other spaced slightly apart.

The delivery upper belt section 93b is comprised of a plurality of pulley sets 93l, 93m and 93n, and an endless belt set 93o. The plurality of pulley sets 93l, 93m and 93n are provided with a predetermined specified number of pulleys at intervals spanning in the cross direction of the divided continuous web W21 and/or W22, and capable of rotation around a center axis parallel to the center axis of the drums of the cutting section 91. The endless belt set 93o is wound around associated pulleys of these pulley sets 93l, 93m, and 93n that have axial positions aligned with each other.

The delivery lower belt section 93c is comprised of a plurality of pulley sets 93p, 93q and 93r, and an endless belt set 93s.

The plurality of pulley sets 93p, 93q and 93r are provided with a predetermined specified number of pulleys at intervals spanning in the cross direction of the divided continuous web W21 and/or W22 so as to be at positions aligned with pulleys of each of the pulley sets 93l, 93m and 93n of the delivery upper belt section 93b, and capable of rotation around a center axis parallel to the center axis of the drums of the cutting section 91. The endless belt set 93s is wound around associated pulleys of these pulley sets 93p, 93q, and 93r that have axial positions aligned with each other.

The pulley set 93l of the delivery upper belt section 93b, and the downstream pulley set 93h of the hopper belt section 93a, are rotatably driven together by a delivery upper belt section drive source, not shown, provided on the same rotational axis and operated under control of the control member 4, with the pulley set 93l rotatably displacing the endless belt set 93o in an anti-clockwise direction in FIG. 7(b), and the downstream pulley set 93h rotatably displacing the one side endless belt set 93j in an anti-clockwise direction in FIG. 7(b). Also, the pulley set 93p of the delivery lower belt section 93c, and the downstream pulley set 93i of the hopper belt section 93a, are rotatably driven together by a delivery lower belt section drive source, not shown, provided on the same rotational axis and operated under control of the control member 4, with the pulley set 93p rotatably displacing the endless belt set 93s in a clockwise direction in FIG. 7(b), and the downstream pulley set 93i rotatably displacing the other side endless belt set 93k in a clockwise direction in FIG. 7(b). Specifically, each belt of the one side endless belt set 93j and the other side endless belt set 93k of the hopper belt section 93a face each other across the traveling path of the divided continuous web W21 and/or W22, and the facing sections sandwich the divided continuous web W21 and/or W22 and move at the same relative speed and in the same relative direction. Also, each belt of the endless belt set 93o of the delivery upper belt section 93b and each belt of the endless belt set 93s of the delivery lower belt section 93c face each other across the traveling path of the divided continuous web W21 and/or W22, and the facing sections sandwich the divided continuous web W21 and/or W22 and move at the same relative speed and in the same relative direction. Accordingly, each belt of the hopper belt section 93a, each belt of the delivery upper belt section 93b and each belt of the delivery lower belt section 93c have opposed sites that are movably displaced at either side of the traveling path of the divided continuous web W21 and/or W22 that are displaced at the same relative speed and in the same relative direction. Still further, the guide in upper belt section drive source (not shown) and the guide in lower belt drive source (not shown) of the guide in section 92, together with the delivery upper belt section drive source (not shown) and the delivery lower belt section drive source (not shown) of the delivery section 93, are controlled by the control member 4 so moving displacement speed of each belt is the same.

The control member 4 has input means 41, connected to several units of the newspaper production systems (SA, SB), namely to the printing unit for printing on one surface and the other surface of a continuous web 1 (1A, 1B), a continuous web supply unit 2 (2A, 2B), and the processing unit 3 (3A, 3B), and is input with newspaper fabrication specifications, etc., for operating the newspaper production system S, as shown in FIG. 1. Travel speed of the continuous webs W1, W2 and the divided continuous webs W21, W22, and rotational speed of the rotating sections, are detected based on required control signals from the several units, for example, pulse signals corresponding to operation amounts for drive sources and operation amounts for rotating center axes output from rotary encoders (not shown) linked to appropriate drive sources or appropriate center axes, and movement distances of the continuous webs W1, W2 and the divided continuous webs W21, W22 are detected and movement positions tracked, and newspapers produced based on newspaper fabrication specifications etc. previously input via the input means 41 while confirming that the arrival of continuous webs W1, W2, divided continuous webs W21, W22 and cut sheets Sn, or the passage of cut sheets Sn, using detectors provided at appropriate positions, for example, photoelectric detectors (not shown).

The control member 4 therefore adjusts operating timing etc. of the printing unit for printing on one surface and the other surface of a continuous web 1 (1A, 1B), the continuous web supply unit 2 (2A, 2B), and of the cutting and folding unit 3a, the folding unit 3b, the divided continuous web course changing unit 3c (overlapping unit 3d or separation unit 3e) and the cutting unit 3f, being each of the processing units 3 (3A, 3B), to control driving of each unit, and adjusts various operation timing between each unit.

Next, operation of the above described structure and a newspaper production method will be described.

With a newspaper production method using the newspaper production system SA that is the first embodiment shown in FIG. 2 to FIG. 5(b) newspaper fabrication specifications are input in advance from the input means 41 to the control member 4, before any printing operations. The newspaper fabrication instructions are, for example, number of pages constituting a single newspaper to be produced, image data for each page, size of cut sheet that are stacked, designation of cut sheet folding conditions, and cut sheet stacking order, etc. As a result of an operation start signal after input of the newspaper fabrication specifications, the following operations are carried out.

A continuous web W1 that is drawn out from a continuous web roll R1 loaded in the continuous web supply unit 2A provided at an upstream side, and that has been subjected to tension adjustment based on detection results of a tension detection section 22a, reaches the printing unit for printing on one surface and the other surface of a continuous web 1A, and is guided by the guide rollers 15a, 15b and 15c to travel substantially horizontally below the ink jet printing devices of the uppermost level, and between the ink jet print heads of each of the ink jet printing devices 11a and 11b, and the back up rollers 17a, 17b, 17c and 17d.

The continuous web W1 has one surface that faces upwards during this passage printed with a first ink, for example a yellow printed image, by the ink jet printing device 11a, and with a second ink, for example cyan printed image, by the ink jet printing device 11b. A first ink printing to one surface start signal is output from the control member 4 to the ink jet printing device 11a at an appropriate timing, and a second ink printing start signal is output from the control member 4 to the ink jet printing device 11b at a timing that is determined based on the printed image using the first ink that it is should be in register with, length of a passage 10a between installation of the ink jet printing device 11a and the ink jet printing device 11b, and travel distance of the continuous web W1. The continuous web W1 that has passed below the ink jet printing devices 11a and 11b has its travel direction changed to downward by the guide roller 15c that contacts the other surface, being the rear surface, to the surface that was printed by the ink jet printing units 11a and 11b, and also, similarly, the travel direction is changed to the opposite of when traveling below the ink jet print devices 11a and 11b of the uppermost level using the guide roller 15d that is in contact with the other surface, to turn the continuous web over. During travel between the guide rollers 15c and 15d, one surface that been printed by the ink jet printing devices 11a and 11b faces the drying unit 16a, and the printed image printed by the ink jet printing devices 11a and 11b is dried.

The continuous web W1 that has a printed image that was printed by the ink jet printing devices 11a and 11b dried and has been turned over together with having travel direction changed by the guide roller 15d is guided by the guide rollers 15d and 15e so as to pass from above to below the ink jet printing devices 11c and 11d of the second level, and travel substantially horizontally between the ink jet print heads of the ink jet printing devices 11c and 11d and the backup rollers 17e, 17f, 17g and 17h, and the other surface that is facing upwards at that time is printed with a first ink, for example, yellow printed image, by the ink jet printing device 11c, and a second ink, for example cyan printed image, by the ink jet printing device 11d. A start signal for printing of first ink to the other surface is output from the control member 4 to the ink jet printing device 11c at a timing determined based on position of each page of a newspaper having one side printed and position of each page of a newspaper printed on the other surface it should be in register with, length of a through passage 10a between the ink jet printing device 11a and the ink jet printing device 11c, and travel distance of the continuous web W1, and a start signal for printing second ink is output from the control member 4 to the ink jet printing device 11d at a timing determined based on printed image by the first ink that it should be in register with, length of a through passage 10a between the ink jet printing device 11a and the ink jet printing device 11d, and travel distance of the continuous web W1.

Next, the continuous web W1 that has passed below the ink jet printing devices 11c and 11d has its travel direction changed to downward by the guide roller 15e that contacts the one surface, being the rear surface, to the surface that was printed by the ink jet printing devices 11c and 11d, and also, similarly, the travel direction is changed to the same direction as when traveling below the ink jet print devices 11a and 11b of the uppermost level using the guide roller 15f that contacts the one surface, to turn the continuous web W1 over again. During travel between the guide rollers 15e and 15f, the other surface that has been printed by the ink jet printing devices 11c and 11d faces the drying unit 16b, and the printed image printed by the ink jet printing devices 11c and 11d is dried. When guiding this continuous web W1, the guide rollers 15e and 15f contact one surface of the continuous web W1, but a printed image printed by the ink jet printing devices 11a and 11b on this one surface has been dried by the drying unit 16a, and so print quality of that printed image is not affected by contact of the guide rollers 15e, 15f with the continuous web W1. The continuous web W1 that has been turned over again together with having travel direction changed by the guide roller 15f is guided by the guide rollers 15f and 15g so as to pass from above to below the ink jet printing devices 11e and 11f of the third level, and travel substantially horizontally between the ink jet print heads of the ink jet printing devices 11e and 11f and the backup rollers 17i, 17j, 17k and 17l, and the one surface that is facing upwards at that time is printed with a third ink, for example, magenta printed image, by the ink jet printing device 11e, and a fourth ink, for example black printed image, by the ink jet printing device 11f. A start signal for printing of third ink to the one surface is output from the control member 4 to the ink jet printing device 11e at a timing determined based on printed image by the first ink and printed image by the second ink it should be in register with, length of a through passage 10a between installation of the ink jet printing device 11a and the ink jet printing device 11e, and travel distance of the continuous web W1, and a start signal for printing fourth ink is output from the control member 4 to the ink jet printing device 11f at a timing determined based on printed image by the first ink and printed image by the second ink and printed image by the third ink that it should be in register with, length of a through passage 10a between the ink jet printing device 11a and the ink jet printing device 11f, and travel distance of the continuous web W1. As a result of this printing, printing to the one surface using four inks is completed.

The continuous web W1 for which printing using four inks on one surface is completed has its travel direction changed to downward by the guide roller 15g that contacts the other surface, being the rear surface, of the surface that was printed by the ink jet printing devices 11e and 11f, and also, similarly, the travel direction is changed to the same as when traveling below the ink jet print devices 11c and 11d of the second level using the guide roller 15h that contacts the other surface, to turn the continuous web W1 over three times. During travel between the guide rollers 15g and 15h, one surface that been printed by the ink jet printing devices 11e and 11f faces the drying unit 16c, and the printed image printed by the ink jet printing devices 11e and 11f is dried. When guiding this continuous web W1, the guide rollers 15g and 15h contact the other surface of the continuous web W1, but a printed image printed by the ink jet printing devices 11c and 11d on this other surface has been dried by the drying unit 16b, and so print quality of that printed image is not affected by contact of the guide rollers 15g, 15h with the continuous web W1. The continuous web W1 that has been turned over a third time together with having travel direction changed by the guide roller 15h is guided by the guide rollers 15h and 15i so as to pass below the ink jet printing devices 11g and 11h of the lower level, and travel substantially horizontally between the ink jet print heads of the ink jet printing devices 11g and 11h and the backup rollers 17m, 17n, 17o and 17p, and the other surface that is facing upwards at that time is printed with a third ink, for example, magenta printed image, by the ink jet printing device 11g, and a fourth ink, for example black printed image, by the ink jet printing device 11h. A start signal for printing of third ink to the other surface is output from the control member 4 to the ink jet printing device 11g at a timing determined based on printed image by the first ink and printed image by the second ink it should be in register with, length of a through passage 10a between installation positions of the ink jet printing device 11a and the ink jet printing device 11g, and travel distance of the continuous web W1, and a start signal for printing fourth ink is output from the control member 4 to the ink jet printing device 11h at a timing determined based on printed image by the first ink and printed image by the second ink and printed image by the third ink that it should be in register with, length of a through passage 10a between installation positions of the ink jet printing device 11a and the ink jet printing device 11h, and travel distance of the continuous web W1. As a result of this printing, printing to the other surface using four inks is completed.

In the above-disclosed printing operation, if the printing for a printed image using each ink for every surface is out of register, the respective registers are adjusted. Specifically, getting printing in register for continuation direction of the continuous web W1 is carried out by performing control by means of the control member 4 so that discharge timing of ink from the ink jet print heads of each of the ink jet print devices 11a to 11h is advanced or delayed, and achieving in register for the cross direction of the continuous web W1 is done by moving the ink jet printing devices 11a to 11h slightly using the lateral moving unit 12a. Also, ink mist arising as a result of discharge from the ink jet print heads and impacting on the continuous web W1 is collected by suction devices 19a to 19h provided at a downstream side in the travel direction of the continuous web W1 for every ink jet printing device 11a to 11h.

The continuous web W1 for which printing using four inks on the other surface is completed, that is, the continuous web W1 for which printing using four inks has been completed for both surfaces, has its travel direction changed to downward by the guide roller 15i that contacts the one surface, being the rear side, of the surface that was printed by the ink jet printing devices 11g and 11h, and also, similarly, the travel direction is changed to substantially the same as when traveling below the ink jet printing devices 11a and 11b of the uppermost level using the guide roller 15j that contacts the other surface, to turn the continuous web W1 over a fourth time. During travel between the guide rollers 15i and 15j, the other surface that has been printed by the ink jet printing devices 11g and 11h faces the drying unit 16e, and the printed image printed by the ink jet printing devices 11g and 11h is dried. When guiding this continuous web W1, the guide rollers 15i and 15j contact one surface of the continuous web W1, but a printed image printed by the ink jet printing devices 11e and 11f on this one surface has been dried by the drying unit 16c, and so print quality of that printed image is not affected by contact of the guide rollers 15i, 15j with the continuous web W1. The continuous web W1 that has been turned over a fourth time together with having the travel direction changed by the guide roller 15j is guided by the guide rollers 15j and 15k, and further delivered to the cutting and folding unit 3a, being the processing unit 3 provided at a downstream side of the printing unit for printing on one surface and the other surface of a continuous web 1A, by the feed delivery mechanism 14a.

The continuous web W1 that has been delivered to the cutting and folding unit 3a is made to travel between the endless belt set 52f of the guide in upper belt section 52a and the endless belt set 52j of the guide in lower belt section 52b of the guide in section 52, and passes between the cutter drum 51a and cutter receiving drum 51b of the cutting section 51 to reach the delivery section 53. The continuous web W1 that has reached the delivery section 53 passes between the two upstream pulley sets 53f and 53g provided spaced slightly far apart facing the hopper belt section 53a, to be sandwiched by the one side endless belt set 53j and the other side endless belt set 53k, and further continues on to the hopper belt section 53a, is sandwiched by the endless belt set 53o of the delivery upper belt section 53b and the endless belt set 53s of the delivery lower belt section 53c, and reaches the path switching section 53e for the direct traveling path provided horizontally while being constrained at least vertically by the one side constraining member 53v and the other side constraining member 53w.

The cutter drum 51a and the cutter receiving drum 51b of the cutting section 51 form cut sheets Sn by cutting the continuous web W1 in accordance with the size of the cut sheets stacked according to the newspaper fabrication specifications input to the control member 4. For example, when the cutter drum 51a and the cutter receiving drum 51b are configured so that when the speed of the peripheral surface is the same as the travel speed of the continuous web W1 the continuous web W1 is cut to a length that is the width dimension of one newspaper page, the control member 4, each time a cut sheet Sn is formed, carries out control to cause the cutter drum 51a and the cutter receiving drum 51b to rotate with a peripheral speed that is the same as the travel speed of the continuous web W1 when designation of the newspaper fabrication specification is a 1-page cut sheet S1, cause the cutter drum 51a and the cutter receiving drum 51b to rotate with a peripheral speed that is half the travel speed of the continuous web W1 when designation of the newspaper fabrication specification is a 2-page cut sheet S2, cause the cutter drum 51a and the cutter receiving drum 51b to rotate with a peripheral speed that is a third the travel speed of the continuous web W1 when designation of the newspaper fabrication specification is a 3-page cut sheet S3, and cause the cutter drum 51a and the cutter receiving drum 51b to rotate with a peripheral speed that is a quarter the travel speed of the continuous web W1 when designation of the newspaper fabrication specification is a 4-page cut sheet S4. Also, cutting using the cutter 51d of the cutter drum 51a and the cutter indent 51e of the cutter receiving drum 51b is required to be aligned with blank sections between adjacent newspaper pages printed on the continuous web W1. Accordingly, rotational phase of the cutter drum 51a and the cutter receiving drum 51b is determined with a structure that detects specified positions of a printed image on the paper surface of the continuous web W1 delivered from the feed mechanism 14a, and based on a paper passage length from that detected position to a position where the cutter 51d of the cutter drum 51a and the cutter indent 51e of the cutter receiving drum 51b mesh.

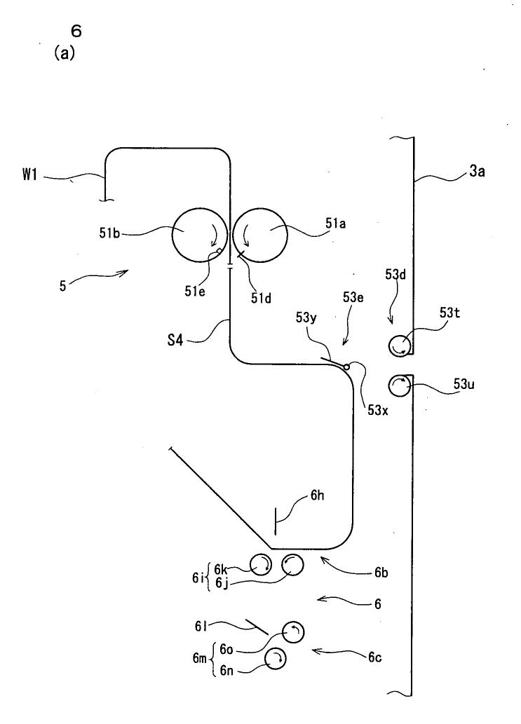

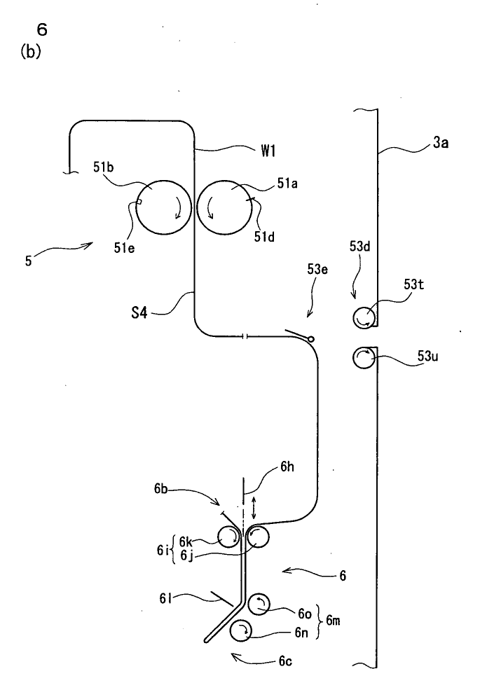

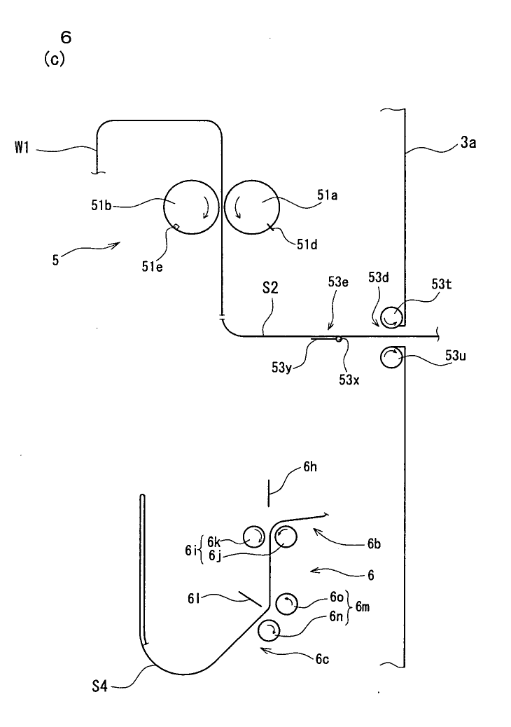

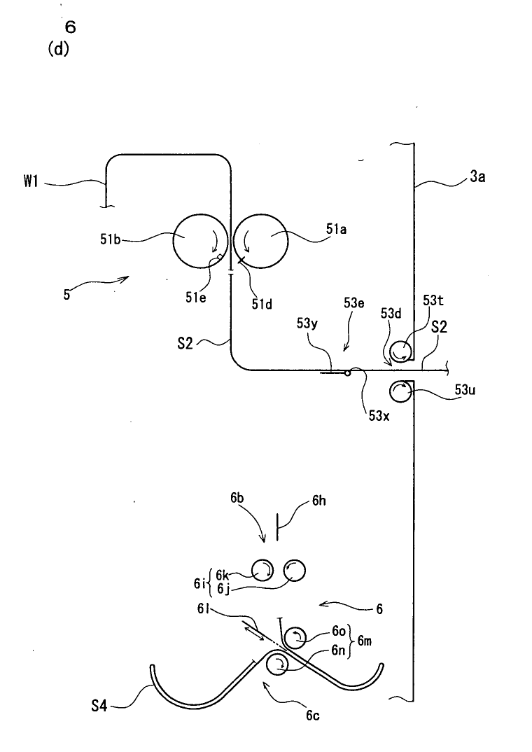

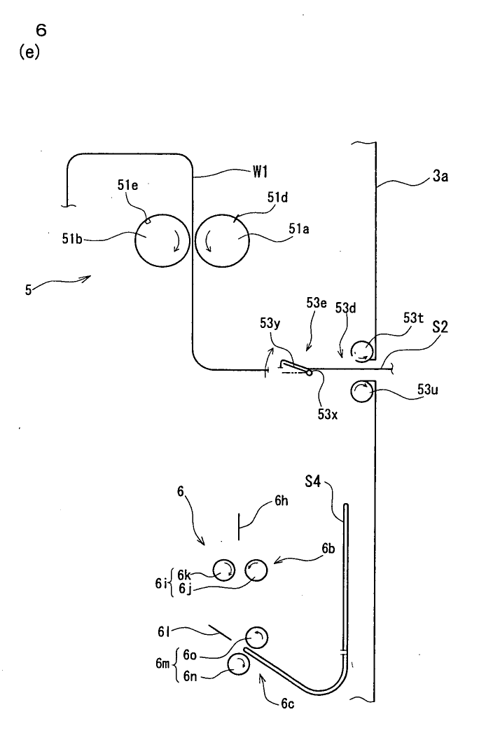

The continuous web W1 that has reached the path switching section 53e reaches the delivery roller 53d by advancing the path switching section 53e along the straight traveling path in accordance with the size of the formed cut sheet Sn, and is sandwiched by the upper roller section 53t and the lower roller section 53u, and is further divided into 1-page cut sheets S1 and 2-page cut sheets S2 that reach the folding unit 3b, being the processing unit 3 provided downstream, and 3-page cut sheets S3 and 4-page cut sheets S4 that reach the pre-folding mechanism 6 as a result of being guided by the path switching member 53y that swings about axis 53x as a pivot point. Specifically, if a leading end formed by the cutting section 51 reaches the path switching section 53e, when that leading end is of a 1-page cut sheet S1 or a 2-page cut sheet S2, the 1-page cut sheet S1 or the 2-page cut sheet S2 are brought to the folding unit 3b by the straight traveling path, and if the leading section is that of a 3-page cut sheet S3 or a 4-page cut sheet S4 then the straight traveling path is blocked off by operation of the path switching member 53y, together with opening of the start end of the pre-folding guide path 6a of the pre-folding mechanism 6 (refer to FIG. 6(e)), and the 3-page cut sheet S3 or the 4-page cut sheet S4 is brought to the pre-folding guide path 6a. An operation signal for the path switching member 53y is output from the control member 4 to the operating control section of a drive source (not shown) at a timing that is determined based on a paper path length between a position where the cutter 51d of the cutter drum 51a and the cutter indent 51e of the cutter receiving drum 51b mesh, and a free end position of the path switching member 53y, and travel distance of the continuous web W1.

Operation of the cutting and folding unit 3a will be described in more detail with reference to FIG. 6(a) to FIG. 6(h).

The continuous web W1 that has been delivered to the cutting and folding unit 3a is cut by the cutting mechanism 5. A leading end of a 4-page cut sheet S4 that has a trailing end formed by this cutting passes a position of the leading side folding section 6b and advances to the first support path 6e having a length corresponding to the width dimension of one newspaper page (refer to FIG. 6(a)).

If the leading end of the 4-page sheet S4 passes a position of the leading side folding section 6b, and advances to the first support path 6e by a length corresponding to the width dimension of one newspaper page, the folding blade 6h of the leading side folding section 6b is operated to insert the middle part between the leading side first page and the second page of the 4-page cut sheet S4 between the folding roller pair 6i rotating in the direction shown by the arrows in the drawing. The 4-page cut sheet S4 that has been inserted between the folding roller pair 6i by operation of the folding blade 6h has the inserted part folded as a leading side fold, and the leading side fold passes a position of the trailing side folding section 6c and approaches the second support path 6f. Also, the rotation direction of the paper feed roller mechanism 6g of the first support path 6e is reversed with operation of the folding blade 6h, and a leading end side of the 4-page cut sheet S4 that has entered the first support path 6e is sent out from the first support path 6e (refer to FIG. 6(b)).

The 4-page cut sheet S4 whose leading side fold line passes the position of the trailing side folding section 6c and that has entered into the second support path 6f has its leading side fold pass the position of the trailing side folding section 6c, and enters into the second support path 6f having a length corresponding to the width dimension of two newspaper pages. Also, while this is happening, a leading end of a 2-page cut sheet S2 following on from the 4-page cut sheet S4 that has had the leading end formed by the cutting passes through the path switching section 53e. At the time of this passage, the path switching member 53y operates to open up the straight travel bath, and the start end of the pre-folding guide path 6a of the pre-folding mechanism 6 is blocked off. As a result, the 2-page cut sheet S2 following on from the 4-page cut sheet S4 is guided into the straight traveling path, and is sandwiched by the upper roller section 53t and the lower roller section 53u of the delivery roller section 53d rotating in the directions shown by arrows in the drawing, and delivered to the folding unit 3b (refer to FIG. 6(c)).

If the leading side fold of the 4-page sheet S4 passes a position of the trailing side folding section 6c, and advances to the second support path 6f having a length corresponding to the width dimension of two newspaper pages, the folding blade 6l of the trailing side folding section 6c is operated to insert the middle part between the leading side third page and the fourth page of the 4-page cut sheet S4, that is the middle of the first page and the second page of the trailing side, between the folding roller pair 6m rotating in the directions shown by the arrows in the drawing. The 4-page cut sheet S4 that has been inserted between the folding roller pair 6m by operation of the folding blade 6l has the inserted part folded as a trailing side fold, and the trailing side fold is advanced towards the rear end of the pre-folding guide path 6a. Also, the drive direction of the paper feed roller mechanism 6g of the second support path 6f is reversed with operation of the folding blade 6l, and a leading side fold line side of the 4-page cut sheet S4 that has entered the second support path 6f is delivered from the second support path 6f (refer to FIG. 6(f)). Still further, together with forming the trailing end of the next 2-page cut sheet S2 that follows on from the 2-page cut sheet S2 that has been guided into the straight traveling path and reached the folding unit 3b by the cutting mechanism 5 while this has been going on, the leading end of the next 2-page cut sheet S2 passes through the path switching section 53e and is guided into the straight traveling path continuing on from the leading 2-page cut sheet S2, and is delivered to the folding unit 3b by the delivery roller section 53d (refer to FIG. 6(d)).

The 4-page cut sheet S4 that has been folded at a trailing side fold line has the trailing side fold made leading in the traveling direction and is further advanced towards the rear end of the pre-folding guide passage 6a, with the inside of the trunk passages 6d further upstream than the trailing side folding section 6c becoming empty. Also, as a result of this advancement, the leading end of the 4-page cut sheet S4 positioned in the center of the 4-page cut sheet by formation of the leading side fold passes through the folding roller pair 6m, but at that time an appropriate not shown guide member is actuated so that the leading end of the 4-page cut sheet S4 advances between the folding roller pair 6m without delay and without the occurrence of any problems such as unnecessary folding. Also, the trailing end of the next 2-page cut sheet S2 reaches the position of the path switching section 53e. At this time, when the newspaper fabrication specifications dictate that the cut sheet Sn continuing on from the next 2-page cut sheet S2 is a 4-page cut sheet S4, the path switching member 53y of the path switching section 53e is operated to block off the straight travel passage while raising up the trailing end of the next 2-page cut sheet S2, together with opening the start end of the pre-folding guide path 6a. Specifically, with the illustrated cutting and folding unit 3a, it is possible to form and pre-fold a new 4-page cut sheet S4 for every two formations of 2-page cut sheets S2 (refer to FIG. 6(e)).

The 4-page cut sheet S4 that has been folded with a trailing side fold has its trailing side fold reach the rear end of the pre-folding guide path 6a. While this is happening, the leading end of the next 4-page cut sheet S4 is advanced to the pre-folding guide path 6a. As required, the 4-page cut sheet S4 that has been folded with a trailing side fold may be held in position if its trailing side fold reaches the rear end of the pre-folding guide path 6a. Accordingly, it is also possible to form and pre-fold a 4-page cut sheet S4 after two or more 2-page cut sheets S2 have been formed. In the event of holding, the paper feed roller mechanism 6g is stopped (refer to FIG. 6(f)).

FIG. 6f shows a case where a 4-page cut sheet S4 that has been folded with a trailing side fold is not held by the pre-folding guide path 6a, wherein the 4-page cut sheet S4 that has been folded with a trailing side fold is delivered to the folding unit 3b by the delivery roller section 53d after going out to the straight traveling path from the rear end of the pre-folding guide path 6a. While this is taking place, the leading end of the next 4-page cut sheet S4 passes the leading side folding section 6b and is advanced to the first support passage 6e (refer to FIG. 6(g)).

If the leading end of the next 4-page sheet S4 passes a position of the leading side folding section 6b, and advances to the first support path 6e by a length corresponding to the width dimension of one newspaper page, then similarly to the description relating to FIG. 6(b), the folding blade 6h of the leading side folding section 6b is operated to form a leading side fold, and further to advance the leading side fold so as to reach a position of the trailing side folding section 6c and advance to the second support passage 6f. The rotation direction of the paper feed roller mechanism 6g of the first support path 6e is reversed with operation of the folding blade 6h, and a leading end side of the 4-page cut sheet S4 that has entered the first support path 6e is sent out from the first support path 6e. Also, while this is taking place the trailing end of the next 4-page cut sheet S4 and the leading end of the 2-page cut sheet S2 following on from the next 4-page cut sheet S4 are formed by the cutting mechanism 5. Then, if the leading end of the new 2-page cut sheet S2 reaches the path switching section 53e, the path switching member 53y is operated to block off the start end of the pre-folding guide path 6a, and open the straight traveling path (refer to FIG. 6(h)).

The reversely rotated paper feed roller mechanism 6g in the description related to FIG. 6(b) to FIG. 6(d), and the stopped paper feed roller mechanism 6g in the description relating to FIG. 6(f) are restored to normal rotation by a signal for prompting operation of the path switching member 53y of the path switching section 53e in order to guide the new 4-page cut sheet S4 to the pre-folding guide path 6a.

The illustrated pre-folding mechanism 6 is also capable of pre-folding a 3-page cut sheet S3.

When the leading side fold is formed in the 3-page cut sheet S3 by the pre-folding mechanism 6, then similarly to the description relating to FIG. 6(b), the fold is formed by the leading side folding section 6b, a formation operation for the trailing side fold is switched to, and the trailing end of the 3-page cut sheet S3 is guided between the folding roller pair 6m of the trailing side folding section 6c by the reverse rotation of the paper feed roller mechanism 6g of the second support path 6f. At this time, appropriate guiding is carried out so that the trailing end of the 3-page cut sheet S3, and the leading end of a 3-page cut sheet S3 positioned at the center of a trailing side page and a center page of the 3-page cut sheet S3 by formation of the leading side fold, are guided between the folding roller pair 6m, without delay and without the occurrence of any problems such as unnecessary folding.

When the trailing side fold is formed in the 3-page cut sheet S3 by the pre-folding mechanism 6, a formation operation for the leading side fold is switched to, and the leading end of the 3-page cut sheet S3 that has reached the leading side folding section 6b is guided between the folding roller pair 6i of the leading side folding section 6b. At this time, an appropriate guide member (not shown) is operated so that the leading end of the 3-page cut sheet S3 is advanced between the folding roller pair 6i, without delay and without the occurrence of any problems such as unnecessary folding. After the leading end of the 3-page cut sheet S3 passes the position of the trailing side folding section 6c and enters into the second support path 6f having a length corresponding to the width dimension of two newspaper pages, then similarly to the description relating to FIG. 6d a trailing side fold is formed by the trailing side folding section 6c.

Besides, it is possible, after the leading end of the 3-page cut sheet S3 has passed the position of the leading side folding section 6b and been advanced to the first support path 6e having a length corresponding to the width dimension of 2 newspaper pages, to form a trailing side fold by operating the folding blade 6h of the leading side folding section 6b to insert a middle of a center page of the 3-page cut sheet S3 and a trailing page between the folding roller pair 6i, and when the trailing side fold has reached the trailing side folding section 6c also forming a trailing side fold by guiding the trailing side fold between the folding roller pair 6m of the trailing side folding section 6c. When guiding the trailing side fold between the folding roller pair 6m of the trailing side folding section 6c, an appropriate guide member (not shown) is operated so that the trailing side fold of the 3-page cut sheet S3 is advanced between the folding roller pair 6m, without delay and without the occurrence of any problems such as unnecessary folding.

In accordance with the designated newspaper fabrication specification, a cut sheet Sn (1-page cut sheet S1, 2-page cut sheet S2, 3-page cut sheet S3 that has been pre-folded to the width dimension of two newspaper pages, and 4-page cut sheet S4 that has been pre-folded to the width dimension of two newspaper pages), that have been printed in an orderly manner by the printing unit for printing on one surface and the other surface of a continuous web 1A, formed by the cutting and folding unit 3a, and delivered to the folding unit 3b by the delivery roller section 53d of the cutting and folding unit 3a, are sandwiched between the upper roller section 7d and the lower roller section 7e of the ejection roller section 7a and the folding unit 3b and ejected to the stacking space 7b of the stacking section 7, and cut sheets Sn in a number corresponding to a single newspaper are sequentially stacked on a receiving member 7f to form a cut sheet bundle GS.

With respect to the loose stacking, a 1-page cut sheet S1 is aligned with a lower diagonal side of the receiving member 7f, that is, at the right side of the receiving member 7f in FIG. 2.

If loose stacking of cut sheets Sn to a number corresponding to a single newspaper is completed, the sheet bundle delivery mechanism 7c is activated and the cut sheet bundle GS on the receiving member 7f is delivered onto the upper plate 8a of the folding mechanism 8 by the delivery member 7g. The speed of delivery at this time is set to slightly faster than the speed of delivery of the earliest cut sheet Sn of the next cut sheet bundle GS by the delivery roller section 53d of the cutting and folding section 3a. Also, the cut sheet bundle GS delivered onto the upper plate 8a of the folding mechanism 8 is subjected to a delivery operation by the delivery member 7g, and is also subjected to conveyance operations of an upstream conveyor section 8f and a downstream conveyor section 8j that operate in synchronism with the sheet bundle feed mechanism 7c to displace the endless belt sets 8i and 8m at the same speed as the delivery speed of the upper plate 8a using the delivery member 7g, to move the leading end until it arrives at the stopper 8c. At the time of this movement, an appropriate guide member (not shown) temporarily at least partially blocks off the opening section so that the leading end of the cut sheet bundle GS is capable of passing through the opening section of a divided section of the upper plate 8a without interference.

The leading end of the cut sheet bundle GS arrives at the stopper 8c slightly earlier, and operation of the folding blade 8e that is waiting at the waiting position commences. Then, when the leading end of the cut sheet bundle GS has reached the stopper 8c, that is, when a central part, in a conveyance direction, of a cut sheet bundle GS has been aligned with the opening section of the upper plate 8a, the insertion tip end of the folding blade 8e is brought into contact with the upper surface of the cut sheet bundle GS, and the cut sheet bundle GS is pressed through the opening section of the upper plate 8a and in between the folding rollers 8n and 8o of the folding roller pair 8d. As a result of this pressing in the central part in the conveyance direction of the cut sheet set GS is gripped by the folding rollers 8n and 8o and folded in half, to form a signature SS having the size of a single newspaper. The signature SS formed folded up by the folding roller pair 8d is guided to the take out section 8q by the guide member 8p provided below the folding roller pair 8d, and conveyed from the newspaper production system SA by the take out section 8q.

After completion of the newspaper production operations of the above described newspaper production system SA, the ink jet printing devices 11a to 11h are moved to a maintenance position shown by the dashed double-dotted line in FIG. 3 and FIG. 4 by a lateral movement unit 12a, and are put on standby below this maintenance position, that is, at a standby position that is lower down than the discharge ports of the ink jet print heads of the ink jet printing devices 11g and 11h, and maintenance such as cleaning of the ink jet print heads so that problems do not arise at the time of the next newspaper production operation are carried out using a maintenance unit 13a provided capable of moving up and down along a frame.

With a newspaper production method using a newspaper production system SB that is the second embodiment shown in FIG. 7(a) to FIG. 12(b), newspaper fabrication specifications are input in advance from the input means 41 to the control member 4, before any printing operations. The newspaper fabrication instructions are, for example, number of pages constituting a single newspaper to be produced, image data for each page, size of cut sheet that are stacked, designation of cut sheet folding conditions, and cut sheet stacking order, etc. The newspaper production method using the newspaper production system SB that is the second embodiment is operated as described in the following as a result of an operation start signal after newspaper fabrication specification input.

The continuous web W2 that has been drawn out from the continuous web roll R2 loaded on the continuous web supply unit 2B provided at an upstream side, and that has been subjected to tension adjustment based on detection results of the tension detection section 22b, reaches the printing unit for printing on one surface and the other surface of a continuous web 1B, and is guided by the guide rollers 15l, 15m and 15n to travel substantially horizontally below the ink jet printing devices 11i, 11j, and 11q 11r of the uppermost level, and through between the ink jet print heads of each of the ink jet printing devices 11i, 11j, and 11q 11r and the backup rollers 18a, 18b, 18c, 18d and 18q, 18r, 18s, 18t, and at another half, in a cross direction, of one surface that faces upwards at this time, printing of first ink, for example yellow printed image, is carried out by the ink jet printing device 11i and printing of second ink, for example cyan printed image, is carried out by the ink jet printing device 11j, while at one half, in the cross direction, of the one surface first ink, for example yellow printed image, is printed by the ink jet printing device 11q and second ink, for example cyan printed image, is printed by the ink jet printing device 11r.

A start signal for printing of first ink to the other half, in the cross direction, of the one surface, and a start signal for printing of first ink to the one half, in the cross direction, of the one surface are output from the control member 4 to the ink jet printing device 11i and to the ink jet printing devices 11q at a predetermined appropriate timing, a start signal for printing of second ink to the other half, in the cross direction, of the one surface is output from the control member 4 to the ink jet printing devices 11j at a timing determined based on a printed image using the first ink for the other half, in the cross direction, of the one surface it should be in register with, length of a paper through passage 10b between installation of the ink jet printing device 11i and the ink jet printing device 11j, and travel distance of the continuous web W2, and a start signal for printing second ink to the one half, in the cross direction, of the one surface is output from the control member 4 to the ink jet printing device 11r at a timing determined based on a printed image using the first ink for the one half, in the cross direction, of the one surface it should be in register with, length of a paper through passage 10b between installation of the ink jet printing device 11q and the ink jet printing device 11r, and travel distance of the continuous web W2.

The continuous web W2 that has passed below the ink jet printing devices 11i, 11j and 11q, 11r has its travel direction changed to downward by the guide roller 15n that contacts the other surface, being the rear surface of the surface that was printed by the ink jet printing devices 11j and 11q, 11r, and also, similarly, the travel direction is changed to the opposite of when traveling below the ink jet printing devices 11i, 11j and 11q, 11r of the uppermost level using the guide roller 15o that is in contact with the other surface, to turn the continuous web W2 over. During travel between the guide rollers 15n and 15o, the one surface that has been printed by the ink jet printing units 11i, 11j and 11q, 11r faces the drying devices 16e, and the printed image printed by the ink jet printing devices 11i, 11j and 11q, 11r is dried.

The continuous web W2, that has had the printed image printed by the ink jet printing devices 11i, 11j and 11q, 11r dried, and travel direction changed by the guide roller 15o together with being turned over, is guided by the guide rollers 15o and 15p to travel substantially horizontally below the ink jet printing devices 11s, 11t, and 11k 11l of the second level, and through between the ink jet print heads of each of the ink jet printing devices 11s, 11t, and 11k 11l and the backup rollers 18u, 18v, 18w, 18x and 18e, 18f, 18g, 18h, and at one half, in a cross direction, of the other surface that faces upwards at this time is printed with a first ink, for example yellow printed image, is carried out by the ink jet printing device 11s and is printed with a second ink, for example cyan printed image, is carried out by the ink jet printing device 11t, while at the other half, in the cross direction, of the other surface first ink, for example yellow printed image, is printed by the ink jet printing device 11k and second ink, for example cyan printed image, is printed by the ink jet printing device 11l.

A start signal for printing of first ink to one half, in the cross direction, of the other surface is output from the control member 4 to the ink jet printing device 11s at a timing determined based on position of each page of a newspaper having one half, in the cross direction, of one surface printed, and position of each page of a newspaper printed on the other half, in the cross direction, of the other surface, that the printing should be in register with, length of a paper through passage 10b between installation positions of the ink jet printing device 11q and the ink jet printing device 11s, and travel distance of the continuous web W2, and a start signal for printing second ink to one half, in the cross direction, of the other surface, is output from the control member 4 to the ink jet printing device 11t at a timing determined based on printed image by the first ink on the one half, in the cross direction, of the other surface that it should be in register with, length of a paper through passage 10b between installation positions of the ink jet printing device 11q and the ink jet printing device 11t, and travel distance of the continuous web W2. Also, a start signal for printing of first ink to the other half, in the cross direction, of the other surface is output from the control member 4 to the ink jet printing device 11k at a timing determined based on position of each page of a newspaper having the other half, in the cross direction, of one surface printed, and position of each page of a newspaper printed on the other half, in the cross direction, of the other surface, that the printing should be in register with, length of a paper through passage 10b between installation positions of the ink jet printing device 11i and the ink jet printing device 11k, and travel distance of the continuous web W2, and a start signal for printing second ink to the other half, in the cross direction, of the other surface, is output from the control member 4 to the ink jet printing device 11l at a timing determined based on printed image by the first ink on the other half, in the cross direction, of the other surface that it should be in register with, length of a paper through passage 10b between installation positions of the ink jet printing device 11i and the ink jet printing device 11l, and travel distance of the continuous web W2.

Next, the continuous web W2 that has passed below the ink jet printing devices 11s, 11t and 11k, 11l has its travel direction changed to downward by the guide roller 15p that contacts the one surface, being the other side to the surface that was printed by the ink jet printing devices 11s, 11t and 11k, 11l, and also, similarly, the travel direction is changed to the same direction as when traveling below the ink jet printing devices 11i, 11j and 11q, 11r of the uppermost level using the guide roller 15q that is in contact with the one surface, to turn the continuous web W2 over again. During travel between the guide rollers 15p and 15q, the other surface that has been printed by the ink jet printing devices 11s, 11t and 11k, 11l faces the drying unit 16f, and the printed image printed by the ink jet printing devices 11s, 11t and 11k, 11l is dried. When guiding this continuous web W2, the guide rollers 15p and 15q contact one surface of the continuous web W2, but a printed image printed by the ink jet printing devices 11i, 11j and 11q, 11r on this one surface has been dried by the drying unit 16e, and so print quality of that printed image is not affected by contact of the guide rollers 15p, 15q with the continuous web W2. The continuous web W2, that has had travel direction changed by the guide roller 15q together with being turned over again, is guided by the guide rollers 15q and 15r to travel substantially horizontally below the ink jet printing devices 11m, 11n, and 11u 11v of the third level, and through between the ink jet print heads of each of the ink jet printing devices 11m, 11n, and 11u 11v and the backup rollers 18i, 18j, 18k, 18l and 18y, 18z, 18aa, 18ab, and at the other half, in a cross direction, of the one surface that faces upwards at this time printing of third ink, for example magenta printed image, is carried out by the ink jet printing device 11m and printing of fourth ink, for example black printed image, is carried out by the ink jet printing device 11n, while at the one half, in the cross direction, of the one surface third ink, for example magenta printed image, is printed by the ink jet printing device 11u and fourth ink, for example black printed image, is printed by the ink jet printing device 11v. A start signal for printing of third ink to the other half, in the cross direction, of the one surface is output from the control member 4 to the ink jet printing device 11m at a timing determined based on the printed image using the first ink and the printed image using the second ink, of the other half, in the cross direction, of the one surface that it should be in register with, length of a paper through passage 10b between installation positions of the ink jet printing device 11i and the ink jet printing device 11m, and travel distance of the continuous web W2, and a start signal for printing fourth ink is output from the control member 4 to the ink jet printing device 11n at a timing determined based on a printed image using the first ink, a printed image using the second ink and printed image using the third ink, of the other half, in the cross direction, of the one surface, that it should be in register with, length of a paper through passage 10b between installation positions of the ink jet printing device 11i and the ink jet printing device 11n, and travel distance of the continuous web W2.

Also, a start signal for third ink printing to one half, in the cross direction, of the one surface, is output from the control member 4 to the ink jet printing device 11u at a timing that is determined based on the printing image using the first ink and the printed image using the second ink, to the one half, in the cross direction, of the one surface, that it should be in register with, length of a paper through passage 10b between installation positions of the ink jet printing device 11q and the ink jet printing device 11u, and travel distance of the continuous web W2. Further, a start signal for fourth ink printing is output from the control member 4 to the ink jet printing device 11v at a timing that is determined based on a printed image using the first ink, a printed image using the second ink and a printed image using the third ink, to the one half, in the cross direction, of the other surface, that it should be in register with, length of a paper through passage 10b between installation positions of the ink jet printing device 11q and the ink jet printing device 11v, and travel distance of the continuous web W2.

As a result of this printing, printing to one half, in the cross direction, of one surface and printing to the other half, in the cross direction, of the one surface, that is, printing using four inks to the one surface, is completed.

The continuous web W2 for which printing using four inks on one surface is completed has its travel direction changed to downward by the guide roller 15r that contacts the other surface, being the other side to the surface that was printed by the ink jet printing devices 11m, 11n and 11u, 11v, and also, similarly, the travel direction is changed to the same as when traveling below the ink jet printing devices 11s, 11t and 11k, 11l of the second level from the top using the guide roller 15s that contacts the other surface, to turn the continuous web W2 over a third time. During travel between the guide rollers 15r and 15s, the one surface that has been printed by the ink jet printing units 11m, 11n and 11u, 11v faces the drying unit 16g, and the printed image printed by the ink jet printing units 11m, 11n and 11u, 11v is dried. When guiding this continuous web W2, the guide rollers 15r and 15s contact the other surface of the continuous web W2, but printed images printed by the ink jet printing units 11s, 11t and 11k, 11l on this other surface has been dried by the drying unit 16f, and so print quality of that printed image is not affected by contact of the guide rollers 15r, 15s with the continuous web W2. The continuous web W2, that has had travel direction changed by the guide roller 15s together with being turned over a third time, is guided by the guide rollers 15s and 15t to travel substantially horizontally below the ink jet printing devices 11w, 11x, and 11o 11p of the lowermost level, and through between the ink jet print heads of each of the ink jet printing devices 11w, 11x, and 11o 11p and the backup rollers 18ac, 18ad, 18ae, 18af and 18m, 18n, 18o, 18p, and at the one half, in a cross direction, of the other surface that faces upwards at this time printing of third ink, for example magenta printed image, is carried out by the ink jet printing devices 11w and printing of fourth ink, for example black printed image, is carried out by the ink jet printing device 11x, while at the other half, in the cross direction, of the other surface third ink, for example magenta printed image, is printed by the ink jet printing device 11o and fourth ink, for example black printed image, is printed by the ink jet printing device 11p.

A start signal for printing of third ink to the one half, in the cross direction, of the other surface is output from the control member 4 to the ink jet printing device 11w at a timing determined based on a printed image using the first ink and printed image using the second ink, to the one half, in the cross direction, of the other surface that it should be in register with, length of a paper through passage 10b between installation positions of the ink jet printing device 11q and the ink jet printing device 11w, and travel distance of the continuous web W2, and a start signal for printing fourth ink is output from the control member 4 to the ink jet printing device 11x at a timing determined based on a printed image using the first ink, a printed image using the second ink and a printed image using the third ink, to the one half, in the cross direction, of the other surface, that it should be in register with, length of a paper through passage 10 between installation positions of the ink jet printing device 11q and the ink jet printing device 11x, and travel distance of the continuous web W2. Also, a start signal for printing of third ink to the other half, in the cross direction, of the other surface is output from the control member 4 to the ink jet printing device 110 at a timing determined based on a printed image using the first ink and the printed image using the second ink, of the other half, in the cross direction, of the other surface, that it should be in register with, length of a paper through passage 10b between installation positions of the ink jet printing device 11i and the ink jet printing device 11o, and travel distance of the continuous web W2, and a start signal for printing fourth ink is output from the control member 4 to the ink jet printing unit 11p at a timing determined based on a printed image using the first ink, a printed image using the second ink and printing image using the third ink, of the other half, in the cross direction, of the other surface, that it should be in register with, length of a paper through passage 10b between installation positions of the ink jet printing device 11i and the ink jet printing device 11p, and travel distance of the continuous web W2. As a result of this printing, printing to one half, in the cross direction, of the other surface and printing to the other half, in the cross direction, of the other surface, that is, printing using four inks to the other surface, is completed.

In the above disclosed printing operation, if the printed image using each ink for the one half, in the cross direction, and the other half, in the cross direction, for each surface, is out of register, the respective registers are adjusted. Specifically, getting printing in register for the continuation direction of the continuous web W2 is carried out by performing control by means of the control member 4 so that discharge timing of ink from the ink jet print heads of each of the ink jet print devices 11i to 11p, and 11q to 11x is advanced or delayed, and achieving in register for the cross direction of the continuous web W2 is done by moving the ink jet printing units 11i to 11p and 11q to 11x slightly using the lateral moving unit 12b. Also, ink mist arising as a result of discharge from the ink jet print heads and impacting on the continuous web W2 is collected by suction devices 19i to 19p and 19q to 19x provided at a downstream side in the travel direction of the continuous web W2 for every ink jet printing devices 11i to 11p and 11q to 11x.

The continuous web W2 for which printing using four inks on the other surface is completed, that is, the continuous web W2 for which printing using four inks has been completed for both surfaces, has its travel direction changed to downward by the guide roller 15t that contacts the one surface, being the rear side of the surface that was printed by the ink jet printing devices 11w, 11x and 11o, 11p, and also, similarly, the travel direction is changed to substantially the same direction as when traveling below the ink jet printing devices 11i, 11j and 11q, 11r of the uppermost level using the guide roller 15u that contacts the other surface, to turn the continuous web W2 over a fourth time. During travel between the guide rollers 15t and 15u, the other surface that has been printed by the ink jet printing devices 11w, 11x and 11o, 11p faces the drying unit 16h, and the printed image printed by the ink jet printing devices 11w, 11x and 11o, 11p is dried. When guiding this continuous web W2, the guide rollers 15t and 15u contact one surface of the continuous web W2, but printed images printed by the ink jet printing devices 11m, 11n and 11u, 11v on this one surface have been dried by the drying unit 16g, and so print quality of those printed images is not affected by contact of the guide rollers 15t, 15u with the continuous web W2. The continuous web W2 that has been turned over a fourth time together with having the travel direction changed by the guide roller 15u is guided by the guide rollers 15u, 15v and 15w, and further delivered to the divided continuous web course changing unit 3c, being the processing unit 3 provided at a downstream side of the printing unit for printing on one surface and the other surface of a continuous web 1B, by the feed mechanism 14b.

The divided continuous web course changing unit 3c, being the processing unit 3, cuts and divides the continuous web W2 in the longitudinal direction at a center part in the cross direction, to form the divided continuous webs W21 and W22, and is a unit for changing the travel directions of these divided continuous webs W21 and W22, so that it is possible to produce a newspaper. The divided continuous web course changing unit 3c has an embodiment D, being the overlapping unit 3d shown in FIG. 7(a), FIG. 7(b) and FIG. 12(a), and an embodiment E, being the separating unit 3e shown in FIG. 11 and FIG. 12(b).

With embodiment D, where the divided continuous web course changing unit 3c is the overlapping unit 3d, as previously described, newspaper surfaces are printed on one half and another half, in the cross direction, for both surfaces by the printing unit for printing on one surface and the other surface of a continuous web 1B, with respective front and rear surface positions being aligned, and the continuous web W2 that has been delivered to the overlapping unit 3d, being the divided continuous web course changing unit 3c, is drawn in to the overlapping unit 3d by the drag roller 30a, together with being cut in the longitudinal direction at a center part on the cross direction by the slitter 30b that is annexed to the drag roller 30a, to give the divided continuous webs W21 and W22. The divided continuous web W21 has its travel direction changed to downwards by the guide rollers 30d and 30f and is guided to the turn bar section 31, while the divided continuous web W22 has its travel direction changed to upwards by the guide rollers 30c and 30e and is guided to the turn bar section 32.

The divided continuous web W21 that has been guided to the turn bar section 31 has its travel direction changed through 90 degrees by rounding 180 degrees around the upstream turn bar 31a, and moving away from the divided continuous web W22, reaches the guide roller 31c where it has its travel direction changed through 180 degrees by rounding 180 degrees around the guide roller 31c, and draws near the divided continuous web W22, and further has travel direction changed through 90 degrees by rounding 180 degrees around the downstream turn bar 31b, to make the travel direction the same as that of the continuous web W2, and a course change is carried out so that the center, in the cross direction, of the divided continuous web W21 and the center, in a cross direction, of the continuous web W2 are placed on the same plane orthogonal to the paper surface of the divided continuous web W21 and the continuous web W2, but separated vertically. Also, the divided continuous web W22 that has been guided to the turn bar section 32 has its travel direction changed through 90 degrees by rounding 180 degrees around the upstream turn bar 32a, and moving away from the divided continuous web W21, reaches the guide roller 32c where it has its travel direction changed 180 degrees by rounding 180 degrees around the guide roller 32c, and draws near the divided continuous web W21, and further has travel direction changed through 90 degrees by rounding 180 degrees around the downstream turn bar 32b, to make the travel direction the same as that of the continuous web W2, and a course change is carried out so that the center, in the cross direction, of the divided continuous web W22 and the center, in a cross direction of the continuous web W2, are placed on the same plane orthogonal to the paper surface of the divided continuous web W22 and the continuous web W2, but separated vertically. The divided continuous web W21 is then guided to the delivery roller 33c by the guide roller 33b, while the divided continuous web W22 is guided to the delivery roller 33c by the guide roller 33a, and the divided continuous webs W21 and W22 are then overlapped on by the peripheral surface of the delivery roller 33c and delivered to the cutting unit 3f, being the processing unit 3, provided at a downstream side, by the delivery roller 33c. If the newspaper page positions of both of the divided continuous webs W21 and W22 are not aligned in the longitudinal direction when the divided continuous webs W21 and W22 are overlapped, the newspaper page positions are adjusted by moving the guide roller 32c in the direction of the arrows in FIG. 12(a) using a not shown traveling path longitudinal adjustment section.

In the case of embodiment E, where the divided continuous web course changing unit 3c is the separation unit 3e, as previously described, newspaper surfaces are printed on one half and another half, in the cross direction, for both surfaces by the printing unit for printing on one surface and the other surface of a continuous web 1B, with respective front and rear surface positions being aligned, and the continuous web W2 that has been delivered to the separation unit 3e, being the divided continuous web course changing unit 3c, is drawn in to the separation unit 3e by the drag roller 30a, together with being cut in the longitudinal direction at a center part in the cross direction by the slitter 30b that is annexed to the drag roller 30a, to give the divided continuous webs W21 and W22. The divided continuous web W21 has its travel direction changed to downwards by the guide rollers 30d and 30f, and is guided as is directly to the guide roller 35b, while the divided continuous web W22 has its travel direction changed to upwards by the guide rollers 30c and 30e and is guided to the turn bar section 34. The divided continuous web W22 that has been guided to the turn bar section 34 has travel direction changed through 90 degrees by rounding 180 degrees around the upstream turn bar 34a, and moving away from the divided continuous web W21, then reaches the downstream turn bar 34b, and has travel direction changing through 90 degrees by rounding 180 degrees around the downstream turn bar 34b to make the travel direction becomes the same as that of the continuous web W2. The divided continuous web W21 that has been guided as is directly from the guide roller 30f to the guide roller 35b, as described above, is then guided to the delivery roller 35d by the guide roller 35b, while the divided continuous web W22 is guided by the guide roller 35a to the delivery roller 35c, and the two divided continuous webs W21 and W22 are separated from each other, with the divided continuous web W21 being delivered to the cutting section 3f, being the processing unit 3 provided at a downstream side, by the delivery roller 35d, and the divided continuous web W22 being delivered by the delivery roller 35c to the cutting unit 3f, being the processing unit 3 provided at a downstream side, that is different to the cutting unit 3f to which the divided continuous web W21 is delivered.

In the embodiment D for the overlapping unit 3d and embodiment E for the separation unit 3e, the divided continuous webs W21 and/or W22 that have been delivered to the cutting unit 3f travel being gripped by the endless belt set 92f of the guide in upper belt section 92a and the endless belt set 92j of the guide in lower belt section 92b, of the guide-in section 92 of the cutting mechanism 9, and pass between the cutter drum 91a and the cutter receiving drum 91b of the cutting section 91 to reach the delivery section 93. The divided continuous web W21 and/or the divided continuous web 22 that have reached the delivery section 93 pass between the two upstream pulley sets 93f and 93g provided spaced slightly far apart facing the hopper belt section 93a, to be sandwiched by the one side endless belt set 93j and the other side endless belt set 93k, and further continue on to the hopper belt section 93a and are sandwiched between the endless belt set 93o of the delivery upper belt section 93b and the endless belt set 93s of the delivery lower belt section 93c, and delivered to the folding unit 3b, being the processing unit provided at a downstream side.

The cutter drum 91a and the cutter receiving drum 91b of the cutting section 91 of the cutting unit 3f form cut sheets Sn by cutting the divided continuous webs W21 and or W22 in accordance with the size of the cut sheets stacked according to the newspaper fabrication specifications input to the control member 4. For example, when the cutter drum 91a and the cutter receiving drum 91b are configured so that when the peripheral surface speed of the drums is the same as the travel speed of the divided continuous web W21 and/or W22 the divided continuous web W21 and/or W22 is cut to a length of the width dimension of one newspaper page, then the control member 4 performs control, each time a cut sheet Sn is made, so that when designation of the newspaper fabrication specification is formation of a 1-page cut sheet S1, the cutter drum 91a and the cutter receiving drum 91b are rotated with a peripheral speed that is the same as the travel speed of the divided continuous web W21 and/or W22, and when the designation of the newspaper fabrication specification is to make a 2-page cut sheet S2 the cutter drum 91a and the cutter receiving drum 91b are rotated with a peripheral speed that is the half the travel speed of the divided continuous web W21 and/or W22. Also, cutting using the cutter 91d of the cutter drum 91a and the cutter indent 91e of the cutter receiving drum 91b is required to be aligned with blank sections between adjacent newspaper pages printed on the divided continuous web W21 and/or W22. Accordingly, rotational phase of the cutter drum 91a and the cutter receiving drum 91b is determined with a structure that detects specified positions of printed images on the paper surface of the divided continuous web W21 and/or W22 delivered from the divided continuous web course changing unit 3c, and based on a paper passage length from that detected position to a position where the cutter 91d of the cutter drum 91a and the cutter indent 91e of the cutter receiving drum 91b mesh.

Since the cutting unit 3f is not provided with the pre-folding mechanism, formation of cut sheets Sn of a size in excess of 2-pages is not carried out.

Cut sheets Sn that have been delivered from the divided continuous web course changing unit 3c to the folding unit 3b are processed in the same way as the cut sheets Sn delivered from the cutting and folding unit 3a to the folding unit 3b, and conveyed from the newspaper production system SB.

After completion of the newspaper production operations of the newspaper production system SB, the ink jet printing devices 11i to 11x are moved to a maintenance position shown by the dashed double-dotted line in FIG. 8 and FIG. 9 by a lateral movement unit 12b, and are put on standby below the maintenance position, that is, at a standby position that is lower down than the discharge ports of the ink jet print heads of the ink jet printing devices 11o, 11p and 11w, 11x, and maintenance such as cleaning of the ink jet print heads so that problems do not arise at the time of the next newspaper production operation are carried out using a maintenance unit 13b provided capable of moving up and down along a frame.

In the newspaper production system SA, it is also possible to provide the cutting unit 3f instead of the cutting and folding unit 3a. It is also possible, in the newspaper production system SB, to provide the cutting and folding unit 3a instead of the cutting unit 3f. However, in the structure of the newspaper production system SB, when the divided continuous web course changing unit 3c is the overlapping unit 3d, since the lightly stacked cut sheets Sn are processed, operating the pre-folding mechanism 6 may become less frequent.

### INDUSTRIAL APPLICABILITY

This invention can be used in newspaper production, and in particular can be used in newspaper production that does not use plates.

1. A newspaper production system for producing newspapers by ink jet printing of each page of a newspaper on one surface and the other surface of a continuous web, and cutting and folding the continuous web, comprising:
an ink jet printing unit having ink jet printing devices, each having an ink jet printing head, provided at a plurality of levels in a vertical direction, and capable of printing on the one surface and the other surface of the continuous web;
a continuous web supply unit provided at an upstream side of the ink jet printing unit capable of printing on the one surface and the other surface of the continuous web and capable of supplying the continuous web from a continuous web roll to the ink jet printing unit capable of printing on the one surface and the other surface of the continuous web;
at least one processing unit provided at a downstream side of the ink jet printing unit capable of printing on the one surface and the other surface of the continuous web, having a cutting mechanism and a folding mechanism, capable of cutting the continuous web that has been printed by the ink jet printing unit capable of printing on the one surface and the other surface to a predetermined size, and capable of folding the cut sheets; and
control member for controlling to cause the continuous web to travel from the continuous web supply unit, via the ink jet printing unit capable of printing on the one surface and the other surface of the continuous web, to the processing unit, and controlling to correlate printing of each page of the newspaper by the ink jet printing unit capable of printing on the one surface and the other surface of the continuous web, in accordance with a travel speed of the continuous web, and the cutting and folding by the processing unit, wherein
the control member causes
the ink jet printing unit capable of printing on the one surface and the other surface of the continuous web to align printing positions of each page of the newspaper on the one surface and the other surface of the continuous web such that a height direction of the newspaper is placed parallel to a cross direction of the continuous web, and while considering a predetermined number of pages constituting one part of a newspaper as one set, to arrange the pages of a newspaper next to each other in a running direction of the continuous web to repetitively print for every set,
and causes the processing unit
to cut the continuous web that has been printed by the ink jet printing unit capable of printing on the one surface and the other surface of the continuous web to form a rectangular cut sheet having a size of a number of pages, being a natural number, printed side by side, in which the same number of pages, being the natural number, are printed on the one surface and the other surface of the rectangular cut sheet and a length of one set of two parallel sides is equal to a height direction length of the newspaper,
then to fold the cut sheets having a size of three or more pages of a newspaper printed side by side, among the rectangular cut sheets, to a size that is, at largest, that of two pages of a newspaper printed side by side,
then to stack each of the cut sheets in a number constituting one part of a newspaper to thereby form a bundle of cut sheets for every one part of the newspaper, and
to fold the bundle of cut sheets for every one part of the newspaper to thereby form a signature newspaper.

2. The newspaper production system of claim 1, wherein
the control member causes the processing unit
to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper,
to stack the cut sheets having a size of two pages of a newspaper printed side by side in a number constituting one part of a newspaper to thereby form a bundle of cut sheets for every one part of the newspaper, and
to fold the bundle of cut sheets for every one part of the newspaper to thereby form a signature newspaper.

3. The newspaper production system of claim 1, wherein
the control member causes the processing unit
to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper,
to form rectangular cut sheets having a size of one printed page of a newspaper for every formation of a predetermined number of cut sheets having a size of one page of a newspaper printed, in which one page of a newspaper is printed on the one surface and the other surface of the rectangular cut sheet and a length of one set of two parallel sides is equal to the height direction length of the newspaper,
to stack the cut sheets having a size of two pages printed side by side and the cut sheets having a size of one printed page of a newspaper in a number constituting one part of the newspaper such that the cut sheets having a size of one printed page of a newspaper overlap on one of the pages printed on the cut sheets having a size of two pages printed side by side to thereby form a bundle of cut sheets for every one part of the newspaper, and
to fold the bundle of cut sheets for every one part of the newspaper to thereby form a signature newspaper.

4. The newspaper production system of claim 1, wherein
the control member causes the processing unit
to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper,
to form, for every formation of a predetermined number of cut sheets having a size of two pages of a newspaper printed side by side, rectangular cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper,
to make the rectangular cut sheets having a size of three pages of a newspaper printed side by side to the same size as that of the cut sheet having a size of two pages of a newspaper printed side by side by folding either one of the side pages thereof to overlap on the middle pages thereof,
to make the rectangular cut sheets having a size of four pages of a newspaper printed side by side to the same size as that of the cut sheets having a size of two pages of a newspaper printed side by side by folding the respective side pages thereof to overlap on respective adjacent pages thereof, and
to stack, in a number constituting one part of the newspaper, the cut sheets having a size of two pages of a newspaper printed side by side, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the same size as that of the cut sheets having a size of two pages of a newspaper printed side by side, to thereby form a bundle of cut sheets for every one part of the newspaper, and
to fold the bundle of cut sheets for every one part of the newspaper to thereby form a signature newspaper.

5. The newspaper production system of claim 1, wherein
the control member causes the processing unit
to cut the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper,
to form, for every formation of a predetermined number of cut sheets having a size of two pages of a newspaper printed side by side, rectangular cut sheets having a size of one printed page of a newspaper, in which one page of a newspaper is printed on the one surface and the other surface of the rectangular cut sheet and a length of one set of two parallel sides is equal to the height direction length of the newspaper, cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper,
to make the rectangular cut sheets having a size of three pages of a newspaper printed side by side the same size as that of the cut sheet having a size of two pages of a newspaper printed side by side by folding either one of the side pages thereof to overlap on the middle pages thereof,
to make the rectangular cut sheets having a size of four pages of a newspaper printed side by side the same size as that of the cut sheets having a size of two pages of a newspaper printed side by side by folding the respective side pages thereof to overlap on respective adjacent pages thereof, and
to stack, in a number constituting one part of the newspaper, the cut sheets having a size of two pages of a newspaper printed side by side, the cut sheets having a size of one page of the newspaper printed, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the size as that of a size of two pages of a newspaper printed side by side such that the cut sheets having a size of one printed page of the newspaper overlap on one of the pages printed on the cut sheets having a size of two pages printed side by side to thereby form a bundle of cut sheets for every one part of the newspaper, and
to fold the bundle of cut sheets for every one part of the newspaper to thereby form a signature newspaper.

6. A production method for newspapers, for producing newspapers using:
an ink jet printing unit having ink jet printing devices, each having an ink jet printing head, provided at a plurality of levels in a vertical direction, and capable of printing on the one surface and the other surface of the continuous web;
a continuous web supply unit provided at an upstream side of the ink jet printing unit capable of printing on the one surface and the other surface of the continuous web and capable of supplying the continuous web from a continuous web roller to the ink jet printing unit capable of printing on the one surface and the other surface of the continuous web;
at least one processing unit provided at a downstream side of the ink jet printing unit capable of printing on the one surface and the other surface of the continuous web, having a cutting mechanism and a folding mechanism, capable of cutting the continuous web that has been printed by the ink jet printing unit capable of printing on the one surface and the other surface to a predetermined size, and capable of folding the cut sheets; and
control member for controlling to cause the continuous web to travel from the continuous web supply unit, via the ink jet printing unit capable of printing on the one surface and the other surface of the continuous web, to the processing unit, and controlling to correlate printing of each page of the newspaper by the ink jet printing unit capable of printing on the one surface and the other surface of the continuous web, in accordance with a travel speed of the continuous web, and the cutting and folding by the processing unit, comprising:
a newspaper sheet printing step of printing on the one surface and the other surface of the continuous web to align printing positions of each page of the newspaper on the one surface and the other surface of the continuous web such that a height direction of the newspaper is placed parallel to a cross direction of the continuous web, and while considering a predetermined number of pages constituting one part of a newspaper as one set, to arrange the pages of a newspaper next to each other in a running direction of the continuous web to repetitively print for every set,
a newspaper sheet cutting step of cutting the continuous web that has been printed by the ink jet printing unit capable of printing on the one surface and the other surface of the continuous web to form a rectangular cut sheet having a size of a number of pages, being a natural number, printed side by side, in which the same number of pages, being the natural number, are printed on the one surface and the other surface of the rectangular cut sheet and a length of one set of two parallel sides is equal to a height direction length of the newspaper,
a first folding step of folding the cut sheets having a size of three or more pages of a newspaper printed side by side, among the rectangular cut sheets, to a size that is, at largest, that of two pages of a newspaper printed side by side,
a newspaper sheet stacking step of stacking each of the cut sheets in a number constituting one part of a newspaper to thereby form a bundle of cut sheets for every one part of the newspaper, and
a second folding step of folding the bundle of cut sheets for every one part of the newspaper to thereby form a signature newspaper.

7. The newspaper production method of claim 6, wherein the newspaper sheet cutting step is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper,
the newspaper sheet stacking step is a step of stacking the cut sheets having a size of two pages of a newspaper printed side by side in a number constituting one part of a newspaper to thereby form a bundle of cut sheets for every one part of the newspaper, and
the second folding step is a step of folding the bundle of cut sheets for every one part of the newspaper to thereby form a signature newspaper.

8. The newspaper production method of claim 6, wherein the newspaper sheet cutting step is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, and forming rectangular cut sheets having a size of one printed page of a newspaper for every formation of a predetermined number of cut sheets having a size of two pages of a newspaper printed side by side, in which one page of a newspaper is printed on the one surface and the other surface of the rectangular cut sheet and a length of one set of two parallel sides is equal to the height direction length of the newspaper,
the newspaper sheet stacking step is a step of stacking the cut sheets having a size of two pages printed side by side and the cut sheets having a size of one printed page of a newspaper in a number constituting one part of the newspaper such that the cut sheets having a size of one printed page of a newspaper overlap on one of the pages printed on the cut sheets having a size of two pages printed side by side to thereby form a bundle of cut sheets for every one part of the newspaper, and
the second folding step is a step of folding the bundle of cut sheets for every one part of the newspaper to thereby form a signature newspaper.

9. The newspaper production method of claim 6, wherein the newspaper sheet cutting step is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, and forming, for every formation of a predetermined number of cut sheets having a size of two pages of a newspaper printed side by side, rectangular cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper,
the first folding step is a step of to make the rectangular cut sheets having a size of three pages of a newspaper printed side by side to the same size as that of the cut sheet having a size of two pages of a newspaper printed side by side by folding either one of the side pages thereof to overlap on the middle pages thereof, so as to make the rectangular cut sheets having a size of four pages of a newspaper printed side by side to the same size as that of the cut sheets having a size of two pages of a newspaper printed side by side by folding the respective side pages thereof to overlap on respective adjacent pages thereof,
the newspaper sheet stacking step is a step of stacking, in a number constituting one part of the newspaper, the cut sheets having a size of two pages of a newspaper printed side by side, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the same size as that of the cut sheets having a size of two pages of a newspaper printed side by side, to thereby form a bundle of cut sheets for every one part of the newspaper, and
the second folding step is a step of folding the bundle of cut sheets for every one part of the newspaper to thereby form a signature newspaper.

10. The newspaper production method of claim 6, wherein the newspaper sheet cutting step is a step of cutting the continuous web that has been printed by the ink jet printing unit capable of printing on the one surface and the other surface of the continuous web to form a rectangular cut sheet having a size of two pages of a newspaper printed side by side, in which two pages of a newspaper are printed side by side on the one surface and the other surface of the rectangular cut sheet and a length of one set of two parallel sides is equal to the height direction length of the newspaper, and forming, for every formation of a predetermined number of cut sheets having a size of two pages of a newspaper printed side by side, rectangular cut sheets having a size of one printed page of a newspaper, in which one page of a newspaper is printed on the one surface and the other surface of the rectangular cut sheet and a length of one set of two parallel sides is equal to the height direction length of the newspaper, cut sheets having a size of three pages of a newspaper printed side by side, in which three pages of a newspaper are printed side by side on the one surface and the other surface of the rectangular cut sheet and a length of one set of two parallel sides is equal to the height direction length of the newspaper, or rectangular cut sheets having a size of four pages of a newspaper printed side by side, in which four pages of a newspaper are printed side by side on the one surface and the other surface of the rectangular cut sheet and a length of one set of two parallel sides is equal to the height direction length of the newspaper,
the first folding step is a step of to make the rectangular cut sheets having a size of three pages of a newspaper printed side by side the same size as that of the cut sheet having a size of two pages of a newspaper printed side by side by folding either one of the side pages thereof to overlap on the middle pages thereof, to make the rectangular cut sheets having a size of four pages of a newspaper printed side by side the same size as that of the cut sheets having a size of two pages of a newspaper printed side by side by folding the respective side pages thereof to overlap on respective adjacent pages thereof,
the newspaper sheet stacking step is a step if stacking, in a number constituting one part of the newspaper, the cut sheets having a size of two pages of a newspaper printed side by side, the cut sheets having a size of one page of the newspaper printed, the cut sheets having a size of three pages of a newspaper printed side by side and folded to the same size as that of the cut sheets having a size of two pages of a newspaper printed side by side, and the cut sheets having a size of four pages of a newspaper printed side by side and folded to the size as that of a size of two pages of a newspaper printed side by side such that the cut sheets having a size of one printed page of the newspaper overlap on one of the pages printed on the cut sheets having a size of two pages printed side by side to thereby form a bundle of cut sheets for every one part of the newspaper, and
the second folding step is a step of folding the bundle of cut sheets for every one part of the newspaper to thereby form a signature newspaper.
